(19) United States
(12) Patent Application Publication
(10) Pub. No.: US 2013/0298547 A1
(43) Pub. Date: Nov. 14, 2013

(54) THERMOACOUSTIC ENGINE

(71) Applicant: HONDA MOTOR CO., LTD, Tokyo (JP)

(72) Inventors: Yosuke Yamamoto, Wako-shi (JP); Toru Kawai, Wako-shi (JP); Haruo Nakamura, Wako-shi (JP)

(73) Assignee: HONDA MOTOR CO., LTD, Tokyo (JP)

(21) Appl. No.: 13/890,629

(22) Filed: May 9, 2013

(30) Foreign Application Priority Data
May 10, 2012 (JP) 2012-108791
May 10, 2012 (JP) 2012-108810
May 10, 2012 (JP) 2012-108833

(51) Int. Cl. F03G 7/00; F25B 9/14

(52) U.S. Cl. CPC F03G 7/00; F25B 9/14
USPC 60/517

(57) ABSTRACT

A thermoacoustic engine includes a first looped pipe provided with a motor configured to convert thermal energy into acoustic energy, a second looped pipe provided with a receiver configured to convert the acoustic energy converted by the motor into thermal energy, and a connecting straight pipe interconnecting the first and second looped. A loop length between one end and an opposite end of the second looped pipe is set to L, the one end and the opposite end being connected with the connecting straight pipe such that acoustic energy is transmitted from the one end to the opposite end. The receiver is disposed within the second looped pipe in a region separated from the one end toward the opposite end by L×(0.6-1).

### FIELD OF THE INVENTION

The present invention relates to a thermoacoustic engine for converting acoustic energy into thermal energy, and particularly relates to a thermoacoustic engine including a first looped pipe and a second looped pipe communicated by a connecting straight pipe, a motor disposed in the first looped pipe, and a receiver disposed in the second looped pipe, wherein acoustic or sound energy converted by the motor is converted into thermal energy by the receiver.

### BACKGROUND OF THE INVENTION

A known example of an apparatus for recovering thermal energy of a heat source (waste heat) is a thermoacoustic engine, which comprises a first looped pipe and a second looped pipe interconnected by a connecting straight pipe, a motor disposed inside the first looped pipe, and a receiver disposed inside the second looped pipe, as disclosed in Japanese Patent Application Laid-Open Publication (JP-A) No. 2011-127870, for example. In the thermoacoustic engine disclosed in JP 2011-127870A, due to the first looped pipe and the second looped pipe being communicated by the connecting straight pipe, a resonant pipe is formed by the first looped pipe, the second looped pipe, and the connecting straight pipe, and a gas (working fluid) is sealed inside the resonant pipe. The thermoacoustic engine is referred to as a so-called double-loop thermoacoustic engine due to including two looped pipes: the first looped pipe and the second looped pipe.

The motor includes a hot-side heat exchanger for exchanging heat with a heat source (a hot-side heat source), and a cold-side heat exchanger for exchanging heat with a cold-side heat source. Furthermore, the receiver includes a hot-side heat exchanger for exchanging heat with the hot-side heat source, and a cold-side heat exchanger for exchanging heat with the cold-side heat source.

In this thermoacoustic engine, thermal energy is converted into sound energy in the motor, the gas in the resonant pipe undergoes self-excited oscillation by the acoustic energy, and acoustic oscillations (sound waves) are generated in the resonant pipe. Furthermore, the generated sound waves are transmitted to the receiver, and the sound energy is converted into thermal energy in the receiver.

Thus, the hot-side heat exchanger of the receiver is brought to room temperature, whereby a temperature lower than room temperature is achieved in the cold-side heat exchanger of the receiver, and the cold-side can be utilized for refrigeration or indoor cooling. By keeping the cold-side heat exchanger of the receiver at ambient temperature, for example, the hot-side heat exchanger of the receiver can be heated to obtain heat, and the thus obtained heat can be utilized for indoor heating or the like.

However, in a double-loop thermoacoustic engine in which the resonant pipe includes two looped pipes: the first looped pipe and the second looped pipe, the conditions for efficiently recovering cold heat energy or heating energy from the receiver have not been clarified. Accordingly, there is a demand for creative ways of efficiently recovering the amount of cold heat and the amount of heat input, and there is yet room for improvement from this standpoint.

Furthermore, considering that the thermoacoustic engine could be driven by the waste heat of an internal combustion engine, approximately 500° C. is envisioned as a heat source temperature for driving the motor. Considering the various losses incurred when the heat transferred to the motor is transmitted to the receiver, a temperature approximately 100 to 200° C. lower (e.g. a temperature of about 350° C.) than the heat source temperature (500° C.) is preferably used for the heat source. However, when the motor is driven with a heat of about 350° C., the shape and other features of the resonant pipe, for example, must be devised in order to efficiently obtain or recover the amount of cold heat or the amount of heat input from the receiver, and there is yet room for improvement from this standpoint.

While the thermoacoustic engine is operating, it is believed that convections and the like occur in the working fluid within the looped pipes, and the heat of the motor moves in correspondence with the flow of the working fluid. Due to the heat of the motor moving, the efficiency of heat exchange by the motor decreases, and it is difficult to suitably recover thermal energy.

To resolve this inconvenience, thermoacoustic engines including jet pumps in the looped pipes are known, such as the one disclosed in Japanese Patent Application Laid-open Publication (JP-A) No. 2005-345023, for example. This thermoacoustic engine includes a jet pump on the receiver side of a looped pipe, whereby the flow channel of the looped pipe can be varied in the vicinity of the receiver. Resistance to the working fluid can thereby be regulated to suppress convections occurring in the working fluid, sound waves can be satisfactorily transmitted, and thermal energy can be suitably recovered.

Also known are thermoacoustic engines having piezoelectric films provided on looped pipes in order to suitably recover thermal energy, such as the one disclosed in Japanese Patent Application Laid-open Publication (JP-A) No. 2006-189219, for example. A piezoelectric film is provided between the motor and the receiver of the looped pipes, and convections occurring in the working fluid are suppressed by the piezoelectric film, whereby sound waves can be satisfactorily transmitted and thermal energy can be suitably recovered.

However, the jet pump disclosed in JP 2005-345023A has a difficulty in varying the flow channel of the looped pipe with precision. Therefore, when the flow channel of the looped pipe is made smaller, for example, there is a risk that the flow channel will be too small, sound wave transmission will be suppressed, and thermal energy recovery will decrease. Furthermore, the configuration of the jet pump is complex, which has been a hindrance to lowering costs.

With the piezoelectric film disclosed in JP 2006-189219A, it is difficult to ensure a desired amount of elongation in regions proximal to the outer periphery of the piezoelectric film because the outer periphery is sandwiched between the pipe walls of the looped pipes. Consequently, it is believed that when the piezoelectric film vibrates with large amplitude, the regions proximal to the outer periphery of the piezoelectric film are damaged. Furthermore, the outer periphery of the piezoelectric film is sandwiched between the pipe walls of the looped pipes. Therefore, it is believed that the regions proximal to the outer periphery are damaged by contact with corners formed at the ends of the pipe walls, and it has been difficult to ensure durability in the piezoelectric film.

### SUMMARY OF THE INVENTION

A first object of the present invention is to provide a thermoacoustic engine which is capable of efficiently obtaining or recovering cold heat energy or heating energy from a receiver of a second looped pipe.

A second object of the present invention is to provide a thermoacoustic engine which is capable of efficiently obtaining or recovering cold heat energy or heating energy from a receiver when a motor is driven with heat of about 350° C.

A third object of the present invention is to provide a thermoacoustic engine which has excellent durability and is capable of suitably recovering thermal energy.

In one aspect of the present invention, there is provided is a thermoacoustic engine, comprising: a first looped pipe provided with a motor configured to convert thermal energy into acoustic energy; a second looped pipe provided with a receiver configured to convert the acoustic energy converted by the motor into thermal energy; and a connecting straight pipe interconnecting the first looped pipe and the second looped pipe, wherein a loop length between one end and an opposite end of the second looped pipe is set to L, the one end and the opposite end of the second looped pipe are connected with the connecting straight pipe such that acoustic energy is transmitted from the one end to the opposite end of the second looped pipe, and the receiver is disposed within the second looped pipe in a region separated from the one end toward the opposite end by L×(0.6-1).

In other words, within the second looped pipe, the receiver is disposed in a region separated from one end toward the opposite end by L×(0.6-1). Consequently, there is no risk that the transmission of acoustic energy, i.e. acoustic vibrations (sound waves) will be suppressed by the receiver. Acoustic energy (sound waves) can thereby be efficiently transmitted to the receiver, and an amount of cold heat or an amount of heat input can be efficiently obtained (recovered) from the receiver.

Preferably, a plurality of receivers are provided in the second looped pipe, the receivers are provided with respective flow channels along the second looped pipe, and the flow channels of one of the receiver which is located near the one end of the second looped pipe have a cross-sectional area greater than a cross-sectional area of the flow channels of another receiver which is located near the opposite end of the second looped pipe. With this arrangement, acoustic vibrations (sound waves) transmitted from the connecting straight pipe to the one end of the second looped pipe are transmitted toward the opposite end, and the one end side of the second looped pipe has greater velocity amplitude of acoustic energy (sound waves) than the opposite end side. Consequently, the receiver having a greater flow channel cross-sectional area can be provided to the region of greater velocity amplitude, and there is accordingly no risk that the transmission of acoustic energy (sound waves) will be suppressed by the receivers. Acoustic energy (sound waves) can thereby be efficiently transmitted to the receivers, and the amount of cold heat and the amount of heat input can be efficiently obtained (recovered) from the receivers.

In another aspect of the present invention, there is provided a thermoacoustic engine comprising: a first looped pipe provided with a motor configured to convert thermal energy into acoustic energy; a second looped pipe provided with a receiver configured to convert the acoustic energy converted by the motor into thermal energy; and a connecting straight pipe interconnecting the first looped pipe and the second looped pipe, wherein a connecting pipe length of the connecting straight pipe is set to be 3 to 8 times a first loop length of the first looped pipe, and a second loop length of the second looped pipe is set to be shorter than the first loop length.

With this arrangement, when the motor is driven with a heat of about 350° C., cold heat or heat input can be efficiently obtained (recovered) from the receiver. Furthermore, cold heat or heat input can be efficiently obtained (recovered) from the receiver due to the second loop length of the second looped pipe being set to be smaller than the first loop length of the first looped pipe.

Preferably, a connecting pipe inside diameter of the connecting straight pipe and a second pipe inside diameter of the second looped pipe are set larger than a first pipe inside diameter of the first looped pipe. With this arrangement, cold heat or heat input can be more efficiently obtained (recovered) from the receiver when the motor is driven with a heat of about 350° C.

In yet another aspect of the present invention, there is provided a thermoacoustic engine in which a motor and a receiver are provided inside a looped pipe, a working fluid is sealed inside the looped pipe, thermal energy is converted into acoustic energy by the motor, and acoustic energy is converted into thermal energy by the receiver, wherein a convection suppression means for suppressing convections in the working fluid is provided at at least one of a cold side of the motor, a cold side of the receiver, and a hot side of the receiver, and the convection suppression means is a film member formed from an elastic material and partitioning the interior of the looped pipe, wherein the convection suppression means has a supported part supported on the looped pipe, a wall part having a base portion integral with the supported part and capable of extending and contracting due to being formed into a cylindrical bellows shape along the looped pipe, and a top part closing a distal end portion of the wall part.

The convection suppression means is formed so that the interior of the looped pipe is partitioned by a film member of an elastic material. Consequently, convections in the working fluid can be suppressed by the convection suppression means. Due to the suppression of convections in the working fluid, the heat of the motor can be kept from moving in correspondence with the flow of the working fluid. Loss of efficiency of heat exchange by the motor is thereby prevented, whereby acoustic energy can be satisfactorily transmitted to the receiver and thermal energy can be suitably recovered.

Furthermore, the wall part of the convection suppression means is formed into a cylindrical bellows shape. Consequently, the convection suppression means can be made to vibrate smoothly without applying any more load (stress) than necessary by extending and contracting the wall part formed into a bellows shape. Thereby, excessive loads (stress) can be prevented from acting on the base portion of the wall part connected to the supported part, damage to the base portion of the wall part can be suppressed, and the durability of the convection suppression means can be ensured.

Additionally, due to the wall part of the convection suppression means being formed into a cylindrical accordion shape, the acoustic energy needed to vibrate (deform) the convection suppression means can be kept low. Thereby, when acoustic energy is transmitted from one side of the convection suppression means to the other side, the attenuation of the acoustic energy can be kept low and thermal energy can therefore be more suitably recovered.

Heat transferred to the motor is transferred in the direction in which acoustic energy is transmitted from the hot side of the motor. In view of this, in the motor, the convection suppression means is provided on the cold side positioned on the side opposite the hot side. Consequently, the convection suppression means is not affected by the heat transferred to the motor. Thereby, the convection suppression means can be prevented from deteriorating due to the effects of the heat transferred to the motor, and the durability of the convection suppression means can be further ensured.

Preferably the convection suppression means is located at a position in proximity to the motor and the receiver and separated by a distance which is at least an amount of elongation of the wall part added to a natural length of the convection suppression means. Therefore, when the convection suppression means vibrates, the convection suppression means can be prevented from interfering with the motor or the receiver. Thereby, the convection suppression means can be kept from interfering with and damaging the motor or the receiver, and the durability of the convection suppression means can be ensured.

Preferably, the wall part has a diameter set to gradually decrease from the base portion toward the distal end portion. The contracting of the bellows-shaped wall part causes the outside diameter of the wall part to increase, and presumably friction is generated between the wall part and the pipe wall. In view of this, the diameter of the wall part is set to gradually decrease from the base portion toward the distal end portion. Consequently, the gaps between adjacent parts of the bellows-shaped wall part can reliably increase in a gradual manner from the base portion toward the distal end portion. It is thereby possible to prevent the bellows-shaped wall part from contacting the pipe wall and friction from occurring between the wall part and the pipe wall when the bellows-shaped wall part is contracted.

### BRIEF DESCRIPTION OF THE DRAWINGS

Several preferred embodiments of the present invention will be described in detail below with reference to the accompanying sheets of drawings, in which:

FIG. 1 is a schematic structural view showing a thermoacoustic engine according to a first embodiment of the present invention;

FIG. 2 is an enlarged view of area 2 in FIG. 1;

FIG. 3 is a cross-sectional view taken along line 3-3 of FIG. 2;

FIG. 4 is a cross-sectional view taken along line 4-4 of FIG. 2;

FIG. 5 is a graph showing the relationship between the amount of cold heat that can be recovered from the upstream receiver and the downstream receiver and the position of the downstream receiver according to the first embodiment;

FIG. 6 is a graph showing the relationship between the amount of cold heat that can be recovered from the upstream receiver and the downstream receiver and the distance between the upstream receiver and the downstream receiver according to the first embodiment;

FIG. 7 is a graph showing the relationship between the amount of cold heat that can be recovered from the upstream receiver and the downstream receiver and the flow channel cross-sectional area of the upstream receiver according to the first embodiment;

FIG. 8 is a schematic structural view of a thermoacoustic engine according to a second embodiment of the present invention;

FIG. 9 is a cross-sectional view showing a resonant pipe of the thermoacoustic engine of the second embodiment shown in FIG. 8;

FIG. 10 is a graph showing the relationship between the oscillation temperature at which the motor is driven and the connecting pipe length of the connecting straight pipe according to the second embodiment;

FIG. 11 is a graph showing the relationship between the connecting pipe length and the amount of cold heat obtained from the receiver in the second embodiment shown in FIG. 9, and also showing relationship between the coefficient of performance (COP) of the thermoacoustic engine and the connecting pipe length;

FIG. 12 is a graph showing the relationship between the oscillating temperature at which the motor is driven and the second loop length of the second looped pipe according to the second embodiment;

FIG. 13 is a graph showing the relationship between the second loop length and the amount of cold heat obtained from the receiver in Embodiment 2, and also showing the relationship between the COP of the thermoacoustic engine and the second loop length;

FIG. 14 is a graph showing the relationship between the oscillating temperature at which the motor is driven, and the second pipe inside diameter and connecting pipe inside diameter according to the second embodiment;

FIG. 15 is a graph showing the relationship between the amount of cold heat obtained from the receiver and the second pipe inside diameter and connecting pipe inside diameter, and also showing the relationship between the COP of the thermoacoustic engine and the second pipe inside diameter and connecting pipe inside diameter according to the second embodiment;

FIG. 16 is a schematic structural view showing a thermoacoustic engine according to a third embodiment of the present invention;

FIG. 17 is an enlarged view of area 17 in FIG. 16;

FIG. 18 is an enlarged view of area 18 in FIG. 17;

FIG. 19A is a cross-sectional view showing an extended state of a convection suppression means in FIG. 18;

FIG. 19B is a cross-sectional view showing a contracted state of the convection suppression means in FIG. 18;

FIG. 20 is a graph showing the relationship between the displacement amplitude and the pressure amplitude of sound waves transmitted through a working fluid according to a third embodiment of the present invention;

FIG. 21 is a cross-sectional view showing a thermoacoustic engine according to a fourth embodiment of the present invention;

FIG. 22 is a cross-sectional view showing a thermoacoustic engine according to a fifth embodiment of the present invention;

FIG. 23A is a cross-sectional view showing an extended state of a convection suppression means of the fifth embodiment shown in FIG. 22;

FIG. 23B is a cross-sectional view showing an contracted state of the convection suppression means in the fifth embodiment shown in FIG. 22;

FIG. 24 is a schematic structural view showing a thermoacoustic engine according to a sixth embodiment of the present invention; and

FIG. 25 is an enlarged view of section 25 in FIG. 24.

### DETAILED DESCRIPTION OF THE PREFERRED EMBODIMENTS

### First Embodiment

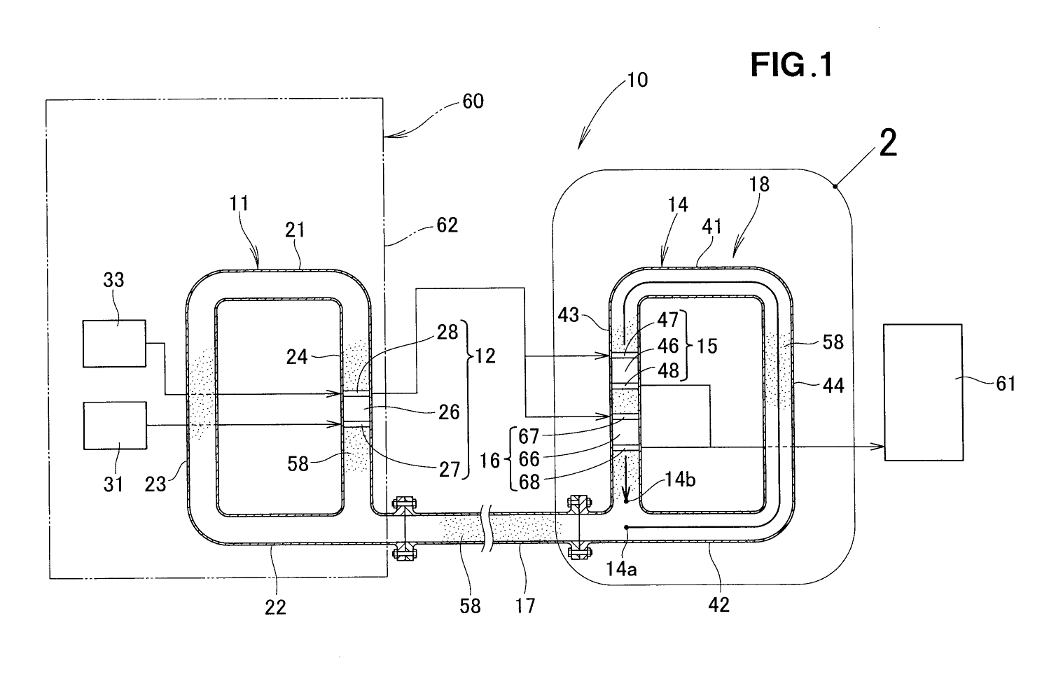

A thermoacoustic engine 10 according to a first embodiment shown in FIG. 1 includes a first looped pipe 11 formed into a looped shape, a motor 12 provided in the first looped pipe 11, a second looped pipe 14 formed into a looped shape, an upstream receiver (a receiver) 15 and a downstream receiver (a receiver) 16 provided in the second looped pipe 14, and a connecting straight pipe 17 interconnecting the first looped pipe 11 and the second looped pipe 14. Specifically, the thermoacoustic engine 10 is a so-called double-loop thermoacoustic engine including two looped pipes: the first looped pipe 11 and the second looped pipe 14.

The first looped pipe 11 is a pipe having a circular cross section made from stainless steel, and is formed into a looped shape from top and bottom horizontal pipe sections 21, 22 and left and right vertical pipe sections 23, 24. The motor 12 is provided in the right vertical pipe section 24 of the first looped pipe 11.

The motor 12 has a sound wave generating function for converting thermal energy to acoustic energy, i.e. to acoustic vibrations (sound waves). This motor 12 includes a stack 26 accommodated inside the right vertical pipe section 24, a hot-side heat exchanger 27 provided at the bottom end of the stack 26, and a cold-side heat exchanger 28 provided at the top end of the stack 26. The hot-side heat exchanger 27 interconnects with a heat source 31 which is capable of supplying waste heat of an internal combustion engine, for example. The cold-side heat exchanger 28 interconnects with a cooling water supply source 33 capable of supplying cooling water.

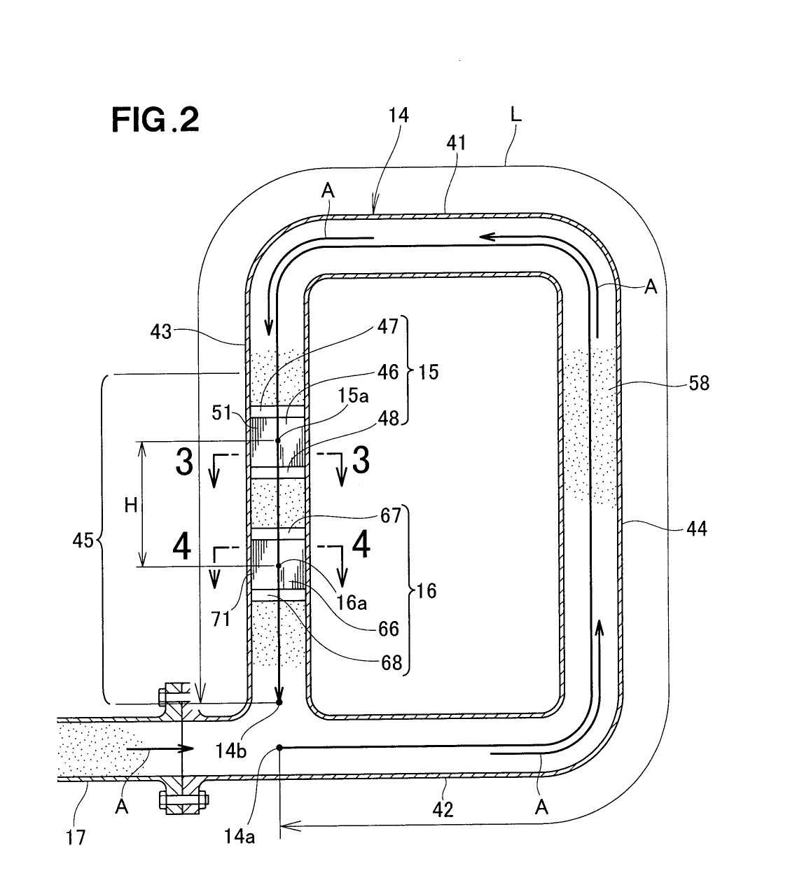

As shown in FIG. 2, the second looped pipe 14, similar to the first looped pipe 11, is a pipe having a circular cross section made from stainless steel, and is formed into a looped shape from top and bottom horizontal pipe sections 41, 42 and left and right vertical pipe sections 43, 44. The second looped pipe 14 is set such that the loop length L between one end 14a and an opposite end 14b of the second looped pipe 14 along an axis of the second looped pipe 14 is 1500 mm. The upstream receiver 15 and the downstream receiver 16 are provided in the left vertical pipe section 43 of the second looped pipe 14.

The upstream receiver 15 has a heat storage function for converting acoustic energy (sound waves) transmitted to the second looped pipe 14 into thermal energy. The upstream receiver 15 includes an upstream stack 46 accommodated inside the left vertical pipe section 43, an upstream hot-side heat exchanger 47 provided at the top end of the upstream stack 46, and an upstream cold-side heat exchanger 48 provided at the bottom end of the upstream stack 46.

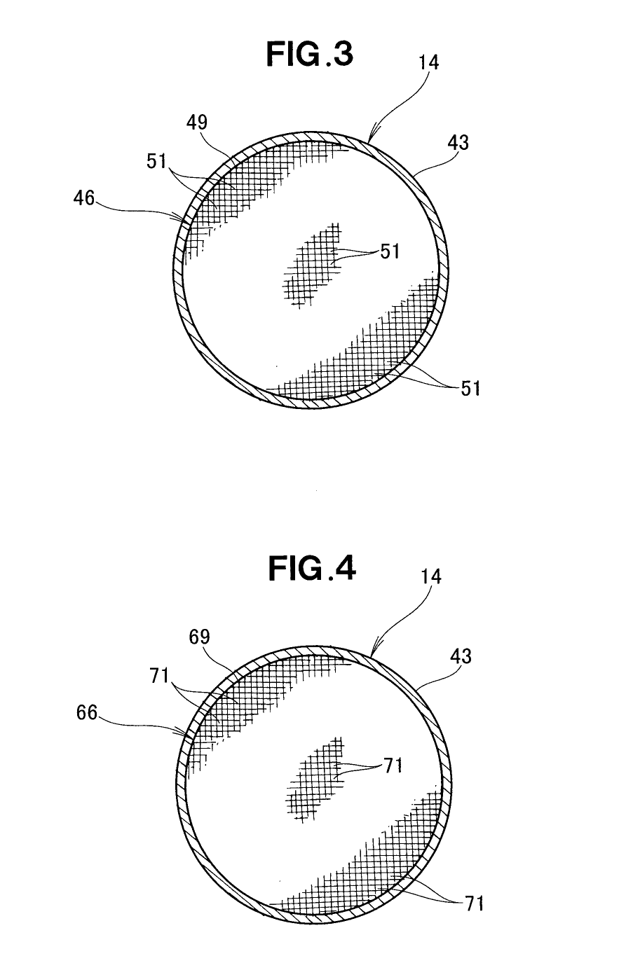

As shown in FIG. 3, the upstream stack 46 comprises multiple mesh sheets 49 stacked inside the left vertical pipe section 43 in the axial direction of the left vertical pipe section 43, with the meshes oriented randomly (disorderly). Stacking the multiple mesh sheets 49 forms multiple upstream tiny flow channels (flow channels) 51 aligned along the axial direction of the left vertical pipe section 43. The top ends and bottom ends of the upstream tiny flow channels 51 interconnect with the interior of the left vertical pipe section 43 (see FIG. 2).

As one example, the mesh sheets 49 are formed from stainless steel (SUS 304) wires (40 mesh, diameter 0.18 mm) into nets having a mesh lattice size (aperture) of 0.46×0.46, thereby yielding an aperture ratio of 51.7%. A flow channel cross-sectional area S1 of the upstream tiny flow channels 51 is appropriately expressed as 0.21 mm² (0.46 mm×0.46 mm), based on the mesh lattice size.

As shown in FIG. 1, in the upstream receiver 15, the upstream hot-side heat exchanger 47 interconnects with the cooling water supply source 33 via the cold-side heat exchanger 28, and the upstream cold-side heat exchanger 48 interconnects with a refrigeration unit 61.

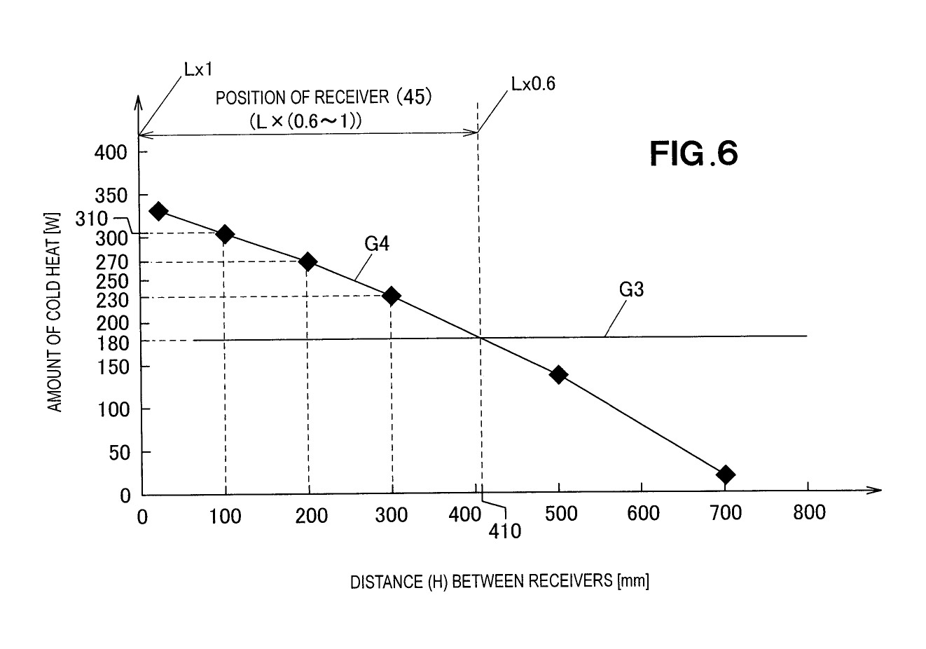

As shown in FIG. 2, the downstream receiver 16 is provided below the upstream receiver 15 at a distance H. The distance H is the distance between a center 15a of the upstream receiver 15 and a center 16a of the downstream receiver 16 that are located on a central axis of the second looped pipe 14. Consequently, the upstream receiver 15 is provided on a side near the one end 14a of the second looped pipe 14, and the downstream receiver 16 is provided on a side near the opposite end 14b of the second looped pipe 14. The reason for ensuring the distance H between the upstream receiver 15 and the downstream receiver 16 will be described in detail in FIG. 6.

Furthermore, the upstream receiver 15 and the downstream receiver 16 are disposed at a position (install position) 45 separated from the one end 14a of the second looped pipe 14 by L×(0.6 to 1) toward the opposite end 14b. The loop length L herein is 1500 mm. Consequently, the install position 45 is 1500×(0.6 to 1)=900 to 1500 mm, and is in the left vertical pipe section 43.

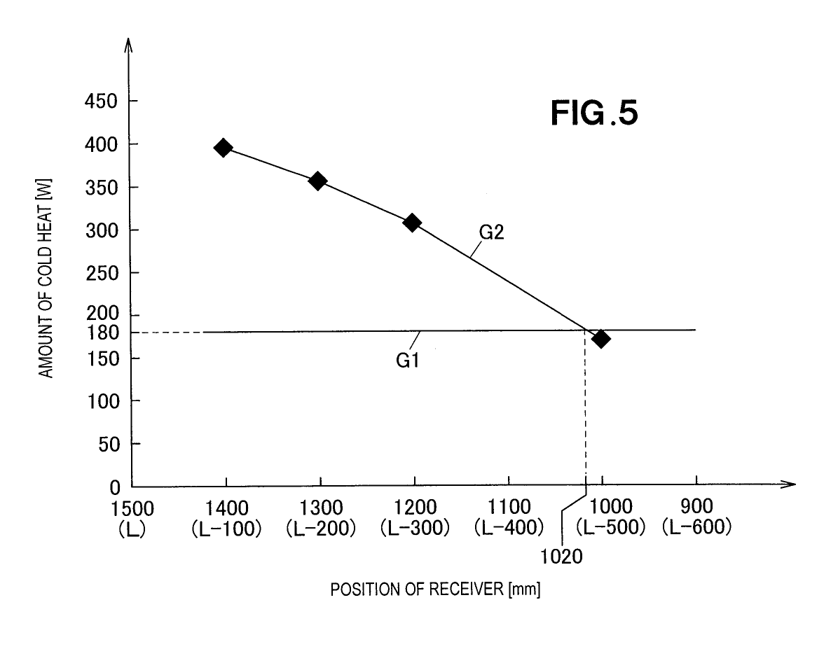

In other words, by setting the position of the one end 14a of the second looped pipe 14 to 0% and the loop length L to 100%, the position of the opposite end 14b of the second looped pipe 14 is at 100%. A position of 900 to 1500 mm separated by 60 to 100% from the one end 14a of the second looped pipe 14 is thereby at the install position 45. The reason for setting the install position 45 of the upstream receiver 15 and downstream receiver 16 to L×(0.6 to 1) is described in detail in FIG. 5.

The downstream receiver 16, similar to the upstream receiver 15, has a heat storage function for converting acoustic energy (sound waves) transmitted to the second looped pipe 14 into thermal energy. The downstream receiver 16 includes a downstream stack 66 accommodated inside the left vertical pipe section 43, a downstream hot-side heat exchanger 67 provided at the top end of the downstream stack 66, and a downstream cold-side heat exchanger 68 provided at the bottom end of the downstream stack 66.

As shown in FIG. 4, the downstream stack 66 comprises multiple mesh sheets 69 stacked inside the left vertical pipe section 43 in the pipe axial direction of the left vertical pipe section 43, with the meshes oriented randomly (disorderly). Stacking the multiple mesh sheets 69 forms multiple downstream tiny flow channels (flow channels) 71 aligned along the axial direction of the left vertical pipe section 43. The top ends and bottom ends of the downstream tiny flow channels 71 interconnect with the interior of the left vertical pipe section 43.

As one example, the mesh sheets 69 are formed from stainless steel (SUS 304) wires (80 mesh, diameter 0.14 mm) into nets having a mesh lattice size (aperture) of 0.178×0.178, thereby yielding an aperture ratio of 31.3%. A flow channel cross-sectional area S2 of the downstream tiny flow channels 71 is appropriately expressed as 0.03 mm² (0.178 mm×0.178 mm), based on the mesh lattice size.

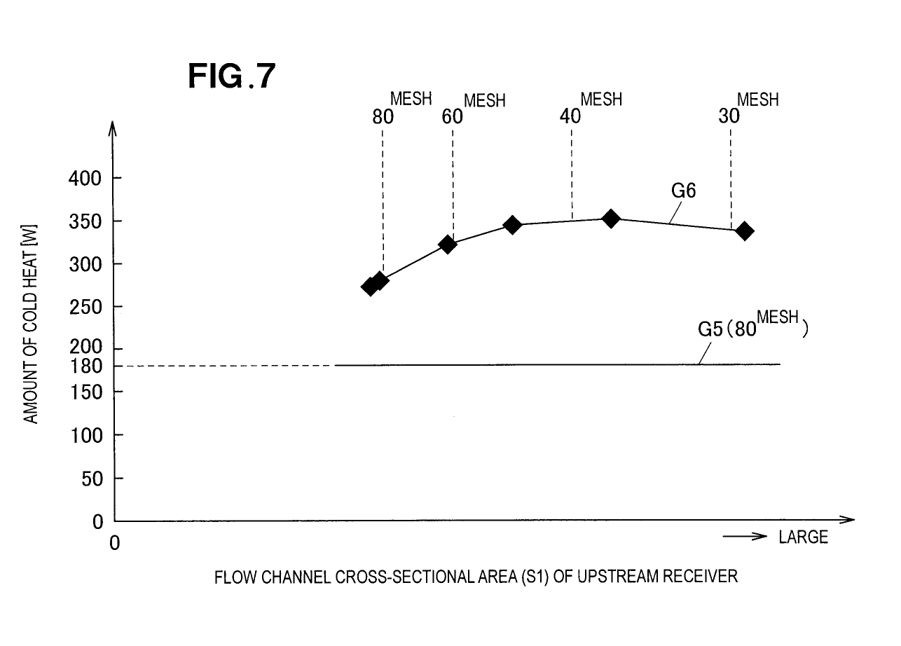

As previously described, the flow channel cross-sectional area S1 of the upstream tiny flow channels 51 is expressed as 0.21 mm². Consequently, the flow channel cross-sectional area S1 of the upstream tiny flow channels 51 provided to the side near the one end 14a of the second looped pipe 14 is set to be greater than the flow channel cross-sectional area S2 of the downstream tiny flow channels 71 provided to the side near the opposite end 14b of the second looped pipe 14. The reason for designing the flow channel cross-sectional area S1 of the upstream tiny flow channels 51 to be greater than the flow channel cross-sectional area S2 of the downstream tiny flow channels 71 is described in detail in FIG. 7.

As shown in FIG. 1, in the downstream receiver 16, the downstream hot-side heat exchanger 67 interconnects with the cooling water supply source 33 via the cold-side heat exchanger 28, and the downstream cold-side heat exchanger 68 interconnects with a refrigeration unit 61.

As shown in FIG. 1, the first looped pipe 11 and the second looped pipe 14 are interconnected by the connecting straight pipe 17. The connecting straight pipe 17 is a pipe having a circular cross section made from stainless steel, similar to the first looped pipe 11 and the second looped pipe 14. A resonant pipe 18 is formed by the first looped pipe 11, the second looped pipe 14, and the connecting straight pipe 17. A gas (an inert gas, a working fluid) 58 such as nitrogen, helium, argon, or a mixed gas of helium and argon is sealed inside the resonant pipe 18.

As shown in FIG. 2, the one end 14a of the second looped pipe 14 continues toward the axial direction along the axial direction of the connecting straight pipe 17. The opposite end 14b of the second looped pipe 14 interconnects with the one end 14a above the axial direction of the connecting straight pipe 17, so as to intersect with the axial direction. Consequently, acoustic vibrations (sound waves) transmitted to the connecting straight pipe 17 are transmitted through the one end 14a of the second looped pipe 14 to the opposite end 14b, as shown by the arrows A.

In the thermoacoustic engine 10 shown in FIG. 1, the hot-side heat exchanger 27 of the motor 12 is heated by the heat source 31, and the cold-side heat exchanger 28 of the motor 12 is cooled by the cooling water supply source 33. The stack 26 thereby oscillates, and the gas 58 in the right vertical pipe section 24 undergoes self-exited oscillation. Due to elf-exited oscillation of the gas 58, acoustic vibrations (sound waves) are generated in the first looped pipe 11, and the generated sound waves are transmitted to the upstream receiver 15 via the connecting straight pipe 17 and the second looped pipe 14.

In this state, the upstream hot-side heat exchanger 47 of the upstream receiver 15 is cooled by cooling water led from the cold-side heat exchanger 28. Consequently, sound waves are transmitted to the upstream receiver 15, the upstream stack 46 vibrates, and the upstream cold-side heat exchanger 48 is cooled.

The sound waves transmitted to the upstream receiver 15 are transmitted to the downstream receiver 16 through the upstream tiny flow channels 51 (FIG. 3). In this state, the downstream hot-side heat exchanger 67 of the downstream receiver 16 is cooled by cooling water led from the cold-side heat exchanger 28. Consequently, due to sound waves being transmitted to the downstream receiver 16, the downstream stack 66 vibrates and the downstream cold-side heat exchanger 68 is cooled.

The two receivers 15, 16 are cooled by the upstream cold-side heat exchanger 48 or the downstream cold-side heat exchanger 68, whereby cooling water cooled by the cold-side heat exchangers 48, 68 is led to the refrigeration unit 61, and the refrigeration unit 61 is kept in a cooled state. Thus, due to the refrigeration unit 61 being cooled by the two receivers (i.e. the upstream receiver 15 and the downstream receiver 16), the refrigeration unit 61 can be sufficiently cooled.

Waste heat of the internal combustion engine provided to a cogeneration system 60 can be used as the heat source 31 due to the first looped pipe 11 of the thermoacoustic engine 10 being accommodated in a casing 62 of the cogeneration system 60, for example. Thereby, in addition to the original function of the cogeneration system 60, which is to recover the waste heat of the internal combustion engine and use the waste heat for indoor heating or the like, a cooling function can also be provided and usability can be improved.

The thermoacoustic engine 10 is a so-called double-loop thermoacoustic engine including two looped pipes: the first looped pipe 11 and the second looped pipe 14. The application can thereby be expanded because the motor 12 of the first looped pipe 11 and the upstream receiver 15 and downstream receiver 16 of the second looped pipe 14 can be divided in two and separated.

Next, the reason for setting the install position 45 of the upstream receiver 15 and the downstream receiver 16 to L×(0.6 to 1) is described based on FIGS. 2 and 5.

FIG. 5 is a graph showing the relationship between the amount of cold heat that can be recovered from the upstream receiver 15 and the downstream receiver 16, and the install position of the downstream receiver 16. The vertical axis represents the amount of cold heat (W), and the horizontal axis represents the install position (mm) of the receivers. A straight line G1 represents the relationship between the position of one receiver and the amount of cold heat. As is apparent from the straight line G1, with one receiver provided in the install position 45 (900 to 1500 mm), an amount of cold heat of 180 W can be recovered from the receiver.

A curve G2 represents the relationship between the position of a downstream one 16 of the two receivers and the amount of cold heat. In the curve G2, the distance H between the two receivers (the upstream receiver 15 and the downstream receiver 16) is set to 100 mm. Consequently, as is apparent from the curve G2, with the downstream receiver 16 located at a position of 1020 to 1500 mm, an amount of cold heat exceeding 180 W can be recovered from the two receivers 15, 16.

Because the distance H between the upstream receiver 15 and the downstream receiver 16 is set to 100 mm, the two receivers 15, 16 can be provided within the range of the install position 45 (900 to 1500 mm) by setting the position of the downstream receiver 16 to 1000 mm. An install position of 1000 mm is in the vicinity of the install position of 1020 mm. Thereby, by providing the two receivers (the upstream receiver 15 and the downstream receiver 16) within the range of the install position 45 (900 to 1500 mm), an amount of cold heat can be more efficiently obtained (recovered) than in the case of one receiver.

Specifically, in the second looped pipe 14, acoustic vibrations (sound waves) are transmitted from the one end 14a to the opposite end 14b as shown by the arrows A. Consequently, it is possible to ensure that the transmission of sound waves is not suppressed by the receivers 15, 16, by providing the upstream receiver 15 and the downstream receiver 16 at an install position 45 separated by L×(0.6 to 1) from the one end 14a toward the opposite end 14b.

An amount of cold heat can thereby be efficiently obtained (recovered) from the receivers 15, 16, because acoustic energy (sound waves) can be efficiently transmitted to the upstream receiver 15 and the downstream receiver 16. In view of this, according to the first embodiment of the present invention, the upstream receiver 15 and the downstream receiver 16 are provided at the position 45 which is separated by L×(0.6 to 1) from the one end 14a toward the opposite end 14b.

Particularly, it is clear from the curve G2 that the amount of recovered cold heat increases as the upstream receiver 15 and the downstream receiver 16 are brought nearer to the opposite end 14b. Consequently, the performance of the thermoacoustic engine 10 can be increased by bringing the upstream receiver 15 and the downstream receiver 16 nearer to the opposite end 14b.

Next, the reason for ensuring the distance H between the upstream receiver 15 and the downstream receiver 16 is described with reference to FIGS. 2 and 6. FIG. 6 is a graph showing the relationship between the amount of cold heat that can be recovered from the upstream receiver 15 and the downstream receiver 16 and the distance H between the upstream receiver 15 and the downstream receiver 16. The vertical axis represents the amount of cold heat (W), and the horizontal axis represents the distance H (mm) between the upstream receiver 15 and the downstream receiver 16. A straight line G3 represents the amount of cold heat that can be recovered from one receiver. As is apparent from the straight line G3, with one receiver provided in the second looped pipe 14, an amount of cold heat of 180 W can be recovered from the receiver.

A curve G4 represents the relationship between the amount of cold heat and the distance H between the upstream receiver 15 and the downstream receiver 16, wherein the tiny flow channels 51 (FIG. 3) of the upstream receiver 15 and the tiny flow channels 71 (FIG. 4) of the downstream receiver 16 are formed from sheets of 80 mesh. As is apparent from the curve G4, by providing the upstream receiver 15 and the downstream receiver 16 to the install position 45 of the two receivers 15, 16, an amount of cold heat exceeding 180 W can be recovered from the two receivers 15, 16.

As evidenced by the curve G4, when the distance H between the upstream receiver 15 and the downstream receiver 16 is 300 mm, an amount of cold heat of 230 W can be recovered. Furthermore, when the distance H between the upstream receiver 15 and the downstream receiver 16 is 200 mm, an amount of cold heat of 270 W can be recovered. When the distance H between the upstream receiver 15 and the downstream receiver 16 is 100 mm, an amount of cold heat of 310 W can be recovered.

Specifically, the amount of recovered cold heat can be increased as the distance H between the upstream receiver 15 and the downstream receiver 16 is set lower. In view of this, the distance H between the upstream receiver 15 and the downstream receiver 16 is preferably set small at 200 mm or less.

Particularly, according to the first embodiment of the invention, the distance H between the upstream receiver 15 and the downstream receiver 16 is set to 100 mm. Thus, the performance of the thermoacoustic engine 10 can be increased by setting the distance H between the upstream receiver 15 and the downstream receiver 16 to be small.

Next, the reason for setting the flow channel cross-sectional area S1 of the upstream receiver 15 to be greater than the flow channel cross-sectional area S2 of the downstream receiver 16 is described based on FIGS. 2 and 7. FIG. 7 is a graph showing the relationship between the amount of cold heat that can be recovered from the upstream receiver 15 and the downstream receiver 16 and the flow channel cross-sectional area S1 of the upstream receiver 15. The vertical axis represents the amount of cold heat (W), and the horizontal axis represents the flow channel cross-sectional area S1 of the upstream receiver 15. A straight line G5 represents the amount of cold heat that can be recovered from one receiver. The size of the mesh sheets forming the tiny flow channels (the flow channels) of the one receiver is 80 mesh. As evidenced by the line G5, an amount of cold heat of 180 W can be recovered from the receiver by forming the tiny flow channels of the receiver from sheets of 80 mesh.

A curve G6 represents the relationship between the amount of cold heat that can be recovered from the upstream receiver 15 and the downstream receiver 16 and the flow channel cross-sectional area S1 of the upstream receiver 15, wherein the distance H between the upstream receiver 15 and the downstream receiver 16 is 200 mm. The tiny flow channels 71 (FIG. 4) of the downstream receiver 16 are formed from sheets of 80 mesh.

As evidenced by the curve G6, by forming the tiny flow channels 71 of the downstream receiver 16 from sheets of 80 mesh and forming the tiny flow channels 51 (see FIG. 3) of the upstream receiver 15 from sheets of 60 mesh or 40 mesh, cold heat can be efficiently obtained (recovered) from the two receivers 15, 16. Specifically, by forming the tiny flow channels 51 of the upstream receiver 15 from sheets of 60 mesh or 40 mesh, the flow channel cross-sectional area S1 of the upstream tiny flow channels 51 can be made larger than the flow channel cross-sectional area S2 of the downstream tiny flow channels 71.

Acoustic vibrations (sound waves) transmitted from the connecting straight pipe 17 to the one end 14a of the second looped pipe 14 are transmitted to the opposite end 14b as shown by the arrows A. Because sound waves are transmitted to the opposite end 14b, the velocity amplitude of the acoustic energy (sound waves) is greater in the side near the one end 14a of the second looped pipe 14 than in the side near the opposite end 14b. Consequently, an upstream receiver 15 having a large flow channel cross-sectional area S1 can be provided to a region of a large velocity amplitude, and there is accordingly no risk of the transmission of acoustic energy (sound waves) being suppressed by the upstream receiver 15.

Specifically, by increasing the flow channel cross-sectional area S1 of the upstream receiver 15, an amount of cold heat can be obtained (recovered) from the upstream receiver 15 by acoustic energy (sound waves), and acoustic energy (sound waves) can be efficiently transmitted to the downstream receiver 16 through the upstream receiver 15. An amount of cold heat can thereby be obtained (recovered) from the downstream receiver 16 by acoustic energy (sound waves).

Thus, by providing an upstream receiver 15 having a large flow channel cross-sectional area S1 to a region of a large velocity amplitude, acoustic energy (sound waves) can be efficiently transmitted to the upstream receiver 15 or the downstream receiver 16, and an amount of cold heat can be efficiently obtained (recovered from the receivers 15, 16. In view of this, according to the first embodiment, the tiny flow channels 71 of the downstream receiver 16 are 80 mesh, the tiny flow channels 51 of the upstream receiver 15 are 40 mesh, and the flow channel cross-sectional area S1 of the upstream receiver 15 is set to be larger than the flow channel cross-sectional area S2 of the downstream receiver 16.

The thermoacoustic engine according to the present invention is not limited to that of the first embodiment described above, and can be appropriately modified and improved. For example, in the first embodiment, two receivers (i.e., the upstream receiver 15 and the downstream receiver 16) were provided as a plurality of receivers, but the invention is not limited to this example; three or more receivers can also be provided.

In the first embodiment described above, cold heat is taken from the upstream receiver 15 and the downstream receiver 16 to cool the refrigeration unit 61 by transferring heat to the motor 12 from the heat source 31, but the invention is not limited to this example; it is also possible for heat to be taken from the receivers 15, 16 and utilized in indoor heating or the like. Specifically, the upstream hot-side heat exchanger 47 of the upstream receiver 15 or the downstream hot-side heat exchanger 67 of the downstream receiver 16 can be heated to obtain (recover) heat, by keeping the upstream cold-side heat exchanger 48 of the upstream receiver 15 or the downstream cold-side heat exchanger 68 of the downstream receiver 16, shown in FIG. 1, at ambient temperature, for example. The thus obtained heat can be utilized to perform indoor heating or the like.

Furthermore, in the first embodiment described above, the upstream receiver 15 and the downstream receiver 16 are provided to the second looped pipe 14, but the invention is not limited to this example; the second looped pipe 14 can be provided with one receiver or with three or more receivers.

### Second Embodiment

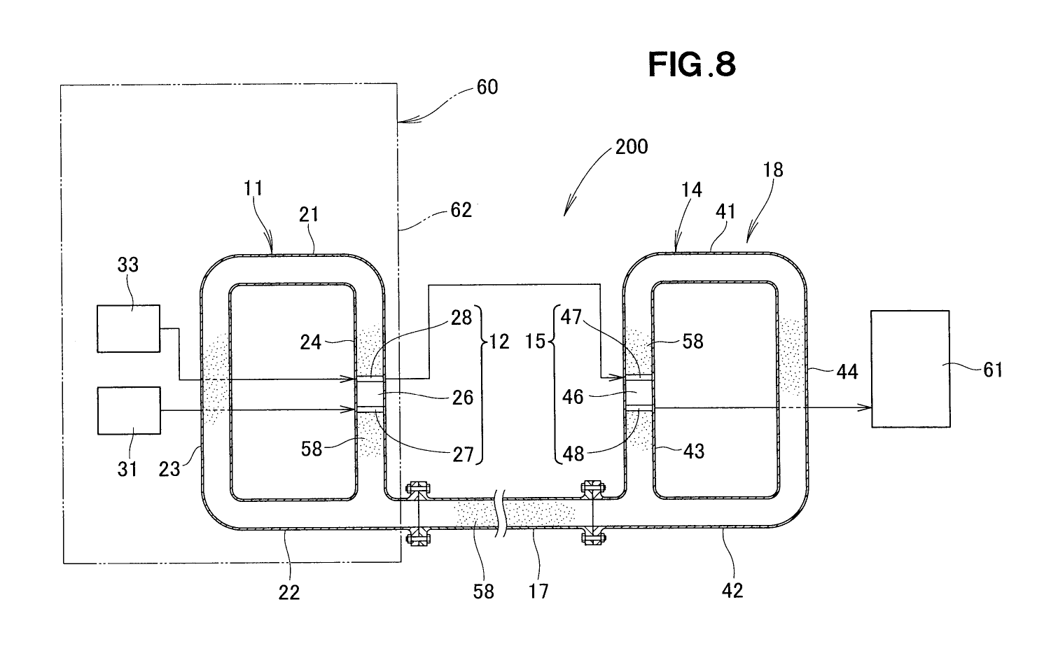

Next, a thermoacoustic engine according to a second embodiment of the present invention is described with reference to FIGS. 8 to 15. In the second embodiment, these members which are identical to those of the first embodiment shown in FIGS. 1 to 7 are described using the same reference characters.

As shown in FIG. 8, the thermoacoustic engine 200 according to the second embodiment includes a first looped pipe 11 formed into a looped shape, a motor 12 provided in the first looped pipe 11, a second looped pipe 14 formed into a looped shape, a receiver 15 (equivalent to the upstream receiver of the first embodiment 15) provided in the second looped pipe 14, and a connecting straight pipe 17 interconnecting the first looped pipe 11 and the second looped pipe 14. Specifically, the thermoacoustic engine 200 of the second embodiment, similar to that of the first embodiment, is a so-called double-loop thermoacoustic engine including two looped pipes: the first looped pipe 11 and the second looped pipe 14.

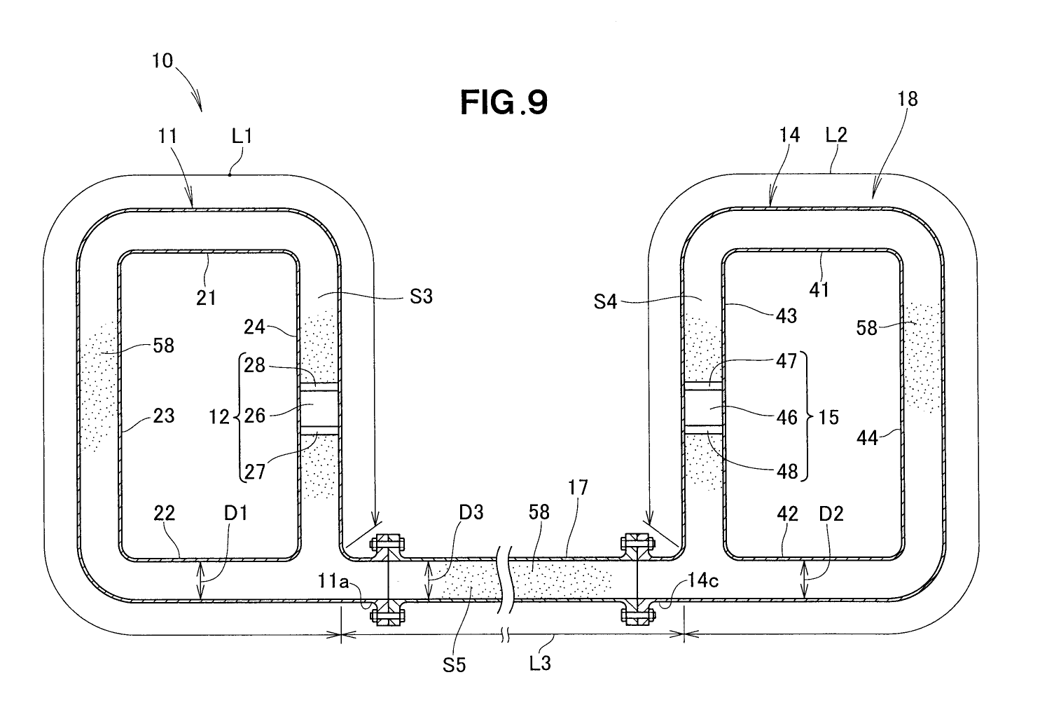

As shown in FIG. 9, the first looped pipe 11 is a pipe having a circular cross section made from stainless steel, and is formed into a looped shape from top and bottom horizontal pipe sections 21, 22 and left and right vertical pipe sections 23, 24. In the first looped pipe 11, the inside diameter of the first looped pipe 11 (referred to as the “first pipe inside diameter” below) is formed to D1, and the axial length of the first looped pipe 11 is set to L1. The axial length L1 of the first looped pipe 11 is referred to below as the “first loop length L1.” Preferably, the first pipe inside diameter D1 is 31 mm, and the first loop length L1 is set to 1.5 m. The motor 12 is provided in the right vertical pipe section 24 of the first looped pipe 11.

As shown in FIG. 8, the motor 12 has a sound wave generating function for converting thermal energy to acoustic energy, i.e. to acoustic vibrations (sound waves). This motor 12 includes a first stack 26 accommodated inside the right vertical pipe section 24, a first hot-side heat exchanger 27 provided at the bottom end of the first stack 26, and a first cold-side heat exchanger 28 provided at the top end of the first stack 26. The first hot-side heat exchanger 27 interconnects with a heat source 31 which is capable of supplying waste heat of an internal combustion engine, for example. The first cold-side heat exchanger 28 interconnects with a cooling water supply source 33 capable of supplying cooling water.

As shown in FIG. 9, the second looped pipe 14, similar to the first looped pipe 11, is a pipe having a circular cross section made from stainless steel, and is formed into a looped shape from top and bottom horizontal pipe sections 41, 42 and left and right vertical pipe sections 43, 44. In the second looped pipe 14, the inside diameter of the second looped pipe 14 (referred to as the “second pipe inside diameter” below) is formed to D2, and the axial length of the second looped pipe 14 is set to L2. The axial length L2 of the second looped pipe 14 is referred to below as the “second loop length L2.”

The second loop length L2 is preferably set to L1×(0.67 to less than 1.0) so as to be less than the first loop length L1. Specifically, a relationship L1×0.67≦L2<L1×1.0 is established. The first loop length L1 is set to 1.5 m. Consequently, the second loop length L2 is preferably set to 1.0 to less than 1.5 m. Specifically, the relationship 1.0 m≦L2<1.5 m is established.

Furthermore, the second pipe inside diameter D2 is set so as to be greater than the first pipe inside diameter D1. Preferably, the cross-sectional area S4 of the hollow part of the second looped pipe 14 is set to (1.1 to 1.5) times the cross-sectional area S3 of the hollow part of the first looped pipe 11. Consequently, the second pipe inside diameter D2 and the first pipe inside diameter D1 have the relationship (D2)²=(D1)²×(1.1 to 1.5). The first pipe inside diameter D1 is set to 31 mm. Consequently, the second pipe inside diameter D2 is preferably set to 32.5 to 38 mm. The receiver 15 (equivalent to the upstream receiver 15 in the first embodiment) is provided in the left vertical pipe section 43 of the second looped pipe 14.

As shown in FIG. 8, the receiver 15 has a thermal storage function for converting acoustic energy (sound waves) transmitted to the second looped pipe 14 to thermal energy. This receiver 15 includes a second stack 46 accommodated inside the left vertical pipe section 43, a second hot-side heat exchanger 47 provided at the top end of the second stack 46, and a second cold-side heat exchanger 48 provided at the bottom end of the second stack 46. The second hot-side heat exchanger 47 interconnects with the cooling water supply source 33 via the first cold-side heat exchanger 28. The second cold-side heat exchanger 48 interconnects with the refrigeration unit 61.

As shown in FIG. 9, the first looped pipe 11 and the second looped pipe 14 are interconnected by the connecting straight pipe 17. Specifically, the connecting straight pipe 17 is a pipe having a circular cross section made from stainless steel, similar to the first looped pipe 11 and the second looped pipe 14, and is made to extend in a straight line so that the right bottom part 11a of the first looped pipe 11 and the left bottom part 14c of the second looped pipe 14 are communicated. A resonant pipe 18 is formed by the first looped pipe 11, the second looped pipe 14, and the connecting straight pipe 17. A gas (an inert gas, a working fluid) 58 such as nitrogen, helium, argon, or a mixed gas of helium and argon is sealed inside the resonant pipe 18.

In the connecting straight pipe 17, the inside diameter of the connecting straight pipe 17 (referred to as the “connecting pipe inside diameter” below) is formed to D3, and the axial length of the connecting straight pipe 17 (i.e. the length of the connecting straight pipe 17) is set to L3. The axial length L3 of the connecting straight pipe 17 is referred to below as the “connecting pipe length L3.” The connecting pipe length L3 is preferably set to 3 to 8 times (L1×3 to 8) the first loop length L1. The first loop length L1 is set to 1.5 m. Consequently, the connecting pipe length L3 is preferably set to 4.5 to 12.0 m.

Furthermore, the connecting pipe inside diameter D3, is formed to the same diameter as the second pipe inside diameter D2, and is set so as to be greater than the first pipe inside diameter D1. Preferably, the cross-sectional area S5 of the hollow part of the connecting straight pipe 17 is set to (1.1 to 1.5) times the cross-sectional area S3 of the hollow part of the first looped pipe 11.

Consequently, the connecting pipe inside diameter D3 and the first pipe inside diameter D1 have the relationship (D3)²=(D1)²×(1.1 to 1.5). The first pipe inside diameter D1 is set to 31 mm. Consequently, the connecting pipe inside diameter D3, similar to the second pipe inside diameter D2, is preferably set to 32.5 to 38 mm.

In the thermoacoustic engine 200 shown in FIG. 8, the first hot-side heat exchanger 27 of the motor 12 is heated by the heat source 31, and the first cold-side heat exchanger 28 of the motor 12 is cooled by the cooling water supply source 33. The first stack 26 thereby oscillates, and the gas 58 in the right vertical pipe 24 undergoes self-excited oscillation. Due to self-exited oscillation of the gas 58, acoustic vibrations (sound waves) are generated in the first looped pipe 11, and the generated sound waves are transmitted to the upstream receiver 15 via the connecting straight pipe 17 and the second looped pipe 14.

In this state, the second hot-side heat exchanger 47 of the receiver 15 is cooled by cooling water led from the first cold-side heat exchanger 28. Consequently, sound waves are transmitted to the receiver 15, the second stack 46 vibrates, and the second cold-side heat exchanger 48 is cooled. The cooling water cooled in the second cold-side heat exchanger 48 is led to the refrigeration unit 61, whereby the refrigeration unit 61 is kept in a cooled state.

Waste heat of the internal combustion engine provided to a cogeneration system 60 can be used as the heat source 31 due to the first looped pipe 11 of the thermoacoustic engine 200 being accommodated in a casing 62 of the cogeneration system 60, for example. Thereby, in addition to the original function of the cogeneration system 60, which is to recover the waste heat of the internal combustion engine and use the waste heat for indoor heating or the like, a cooling function can also be provided and usability can be improved.

The thermoacoustic engine 200 is a so-called double-loop thermoacoustic engine including two looped pipes: the first looped pipe 11 and the second looped pipe 14. The application can thereby be expanded because the motor 12 of the first looped pipe 11 and the receiver 15 of the second looped pipe 14 can be divided in two and separated.

When the thermoacoustic engine 200 is driven by the waste heat of the internal combustion engine or the like, for example, considering the various losses incurred when the heat transferred to the motor 12 is transmitted to the receiver 15, a temperature of about 350° C. is preferably used as the heat source. When the motor 12 is driven by heat of about 350° C., a resonant pipe 18 is formed in the following manner in order to efficiently obtain (recover) an amount of cold heat or an amount of heat input from the receiver 15.

Specifically, the connecting pipe length L3 is set to L1×(3 to 8) as previously described. The second loop length L2 is set lower than the first loop length L1, at L1×(0.67-less than 1.0). Furthermore, the cross-sectional area S4 of the second looped pipe 14 and the cross-sectional area S5 of the connecting straight pipe 17 are set large at (1.1 to 1.5) times the cross-sectional area S3 of the first looped pipe 11.

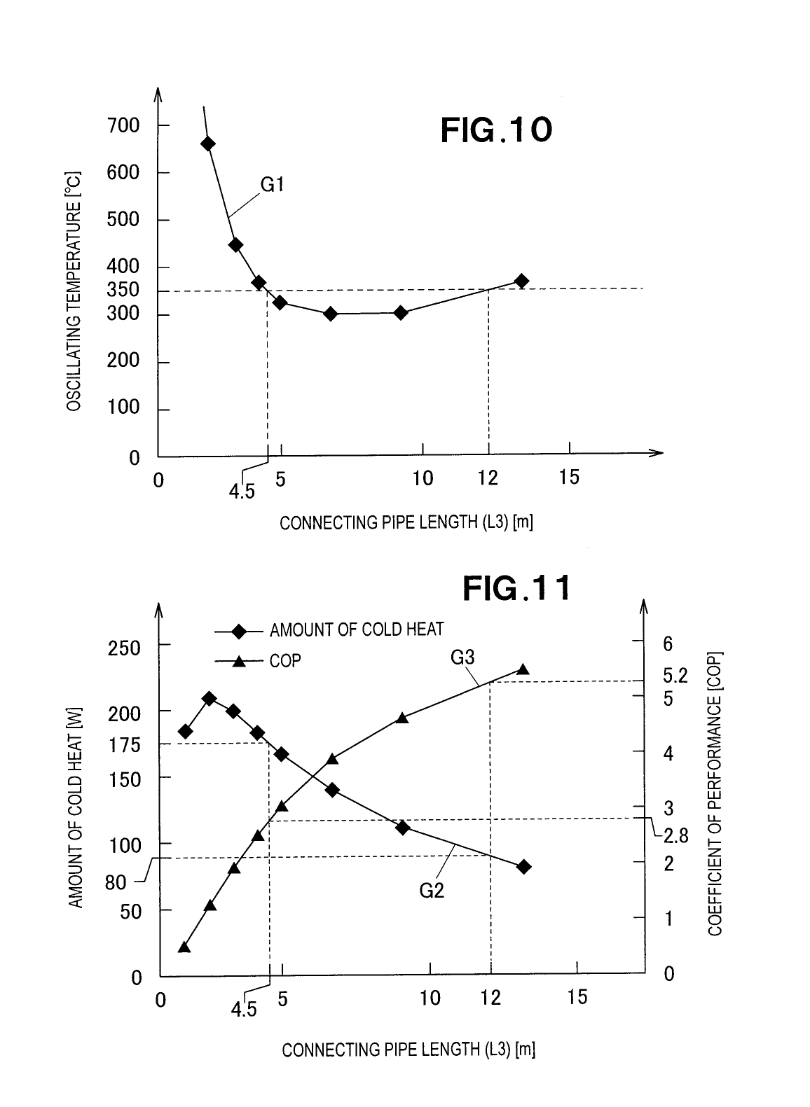

The reason that the connecting pipe length L3 of the connecting straight pipe 17 is preferably set to L1×(3 to 8) relative to the first loop length L1 of the first looped pipe 11 shown in FIG. 9 is described with reference to FIGS. 10 and 11. Specifically, the first loop length L1 of the first looped pipe 11 is 1.5 m, and the connecting pipe length L3 of the connecting straight pipe 17 is 4.5 to 12.0 m. Another condition of the resonant pipe 18 is that the second loop length L2 of the second looped pipe 14 be 1.5 m, similar to the first looped pipe 11. Furthermore, the inside diameters D1, D2, and D3 of the first looped pipe 11, the second looped pipe 14, and the connecting straight pipe 17 are 31 mm.

FIG. 10 is a graph showing the relationship between the temperature at which the motor 12 is driven (referred to as the “oscillating temperature” below) and the connecting pipe length L3 of the connecting straight pipe 17, wherein the vertical axis represents the oscillating temperature (° C.) and the horizontal axis represents the connecting pipe length L3 (m). A curve G1 represents the relationship between the oscillating temperature and the connecting pipe length L3.

FIG. 11 is a graph showing the relationship between the amount of cold heat obtained from the receiver 15 and the connecting pipe length L3, and also describing the relationship between the coefficient of performance (referred to as the “COP” below) of the thermoacoustic engine 200 and the connecting pipe length L3. A curve G2 represents the amount of cold heat obtained from the receiver 15, and a curve G3 represents the COP of the thermoacoustic engine 200. The left vertical axis represents the amount of cold heat (W), the right vertical axis represents the COP, and the horizontal axis represents the connecting pipe length L3 (m).

As evidenced by the curve G1 of FIG. 10 and the curves G2 and G3 of FIG. 11, when the connecting pipe length L3 of the connecting straight pipe 17 is set to less than 4.5 m and the oscillating temperature is increased above 350° C., a sufficient amount of cold heat can be recovered from the receiver 15. However, it is difficult to suitably ensure a COP, and it is also difficult to ensure energy consumption efficiency.

When the connecting pipe length L3 of the connecting straight pipe 17 is set above 12 m and the oscillating temperature is increased above 350° C., it is possible to suitably ensure a COP. However, it is difficult to recover a sufficient amount of cold heat from the receiver 15.

In view of this, the connecting pipe length L3 of the connecting straight pipe 17 is set to 4.5 to 12 m and the oscillating temperature is kept at about 350° C. The COP of the thermoacoustic engine 200 can thereby be ensured in a range of 2.8 to 5.2, and a high energy consumption efficiency can be preserved. Furthermore, by setting the connecting pipe length L3 to 4.5 to 12 m and keeping the oscillating temperature at about 350° C., the amount of cold heat obtained from the receiver 15 can be sufficiently increased to 80 to 175 W. Specifically, by setting the connecting pipe length L3 to L1×(3 to 8) and driving the motor 12 with a heat of about 350° C., a sufficient amount of cold heat can be efficiently obtained (recovered) from the receiver 15.

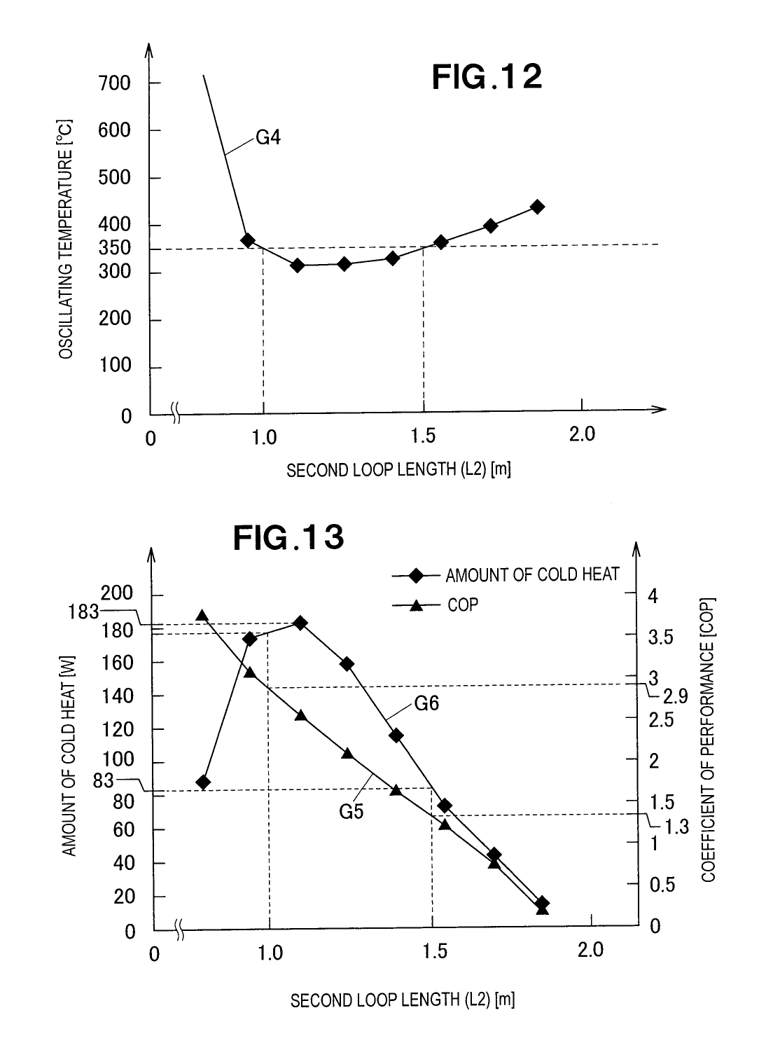

Next, the reason that the second loop length L2 of the second looped pipe 14 is preferably set to L1×(0.67-less than 1.0) relative to the first loop length L1 of the first looped pipe 11 shown in FIG. 9 is described with reference to FIGS. 12 and 13. Specifically, the first loop length L1 of the first looped pipe 11 is 1.5 m, and the second loop length L2 of the second looped pipe 14 is 1.0 to 1.5 m. Another condition of the resonant pipe 18 is that the connecting pipe length L3 of the connecting straight pipe 17 be 4.5 to 12.0 m. Furthermore, the inside diameters D1, D2, and D3 of the first looped pipe 11, the second looped pipe 14, and the connecting straight pipe 17 are 31 mm.

FIG. 12 is a graph showing the relationship between the oscillating temperature at which the motor 12 is driven and the second loop length L2 of the second looped pipe 14, wherein the vertical axis represents the oscillating temperature (° C.) and the horizontal axis represents the second loop length L2 (m). A curve G4 shown in FIG. 12 represents the relationship between the oscillating temperature and the second loop length L2.

FIG. 13 is a graph showing the relationship between the amount of cold heat obtained from the receiver 15 and the second loop length L2, and also showing the relationship between the coefficient of performance of the thermoacoustic engine 200 and the second loop length L2. A curve G5 represents the COP of the thermoacoustic engine 200, and a curve G6 represents the amount of cold heat obtained from the receiver 15. The left vertical axis represents the amount of cold heat (W), the right vertical axis represents the COP, and the horizontal axis represents the second loop length L2 (m).

The curve G4 of FIG. 12 and the curves G5 and G6 of FIG. 13 show that when the second loop length L2. of the second looped pipe 14 is set to less than 1.0 m and the oscillating temperature is increased above 350° C., a sufficient amount of cold heat can be recovered from the receiver 15. However, it is difficult to suitably ensure a COP, and it is also difficult to ensure energy consumption efficiency.

When the second loop length L2 of the second looped pipe 14 is set to 1.5 m or greater and the oscillating temperature is increased above 350° C., it is difficult to suitably ensure a COP, and it is also difficult to recover a sufficient amount of cold heat from the receiver 15.

In view of this, the second loop length L2 of the second looped pipe 14 is set to 1.0 to 1.5 m and the oscillating temperature is kept at about 350° C. The COP of the thermoacoustic engine 200 can thereby be ensured in a range of 1.3 to 2.9, and a high energy consumption efficiency can be preserved. Furthermore, by setting the second loop length L2 to 1.0 to 1.5 m and keeping the oscillating temperature at about 350° C., the amount of cold heat obtained from the receiver 15 can be sufficiently increased to 83 to less than 183 W. Specifically, by setting the second loop length L2 to L1×(0.67-less than 1.0) and driving the motor 12 with a heat of about 350° C., a sufficient amount of cold heat can be efficiently obtained (recovered) from the receiver 15.

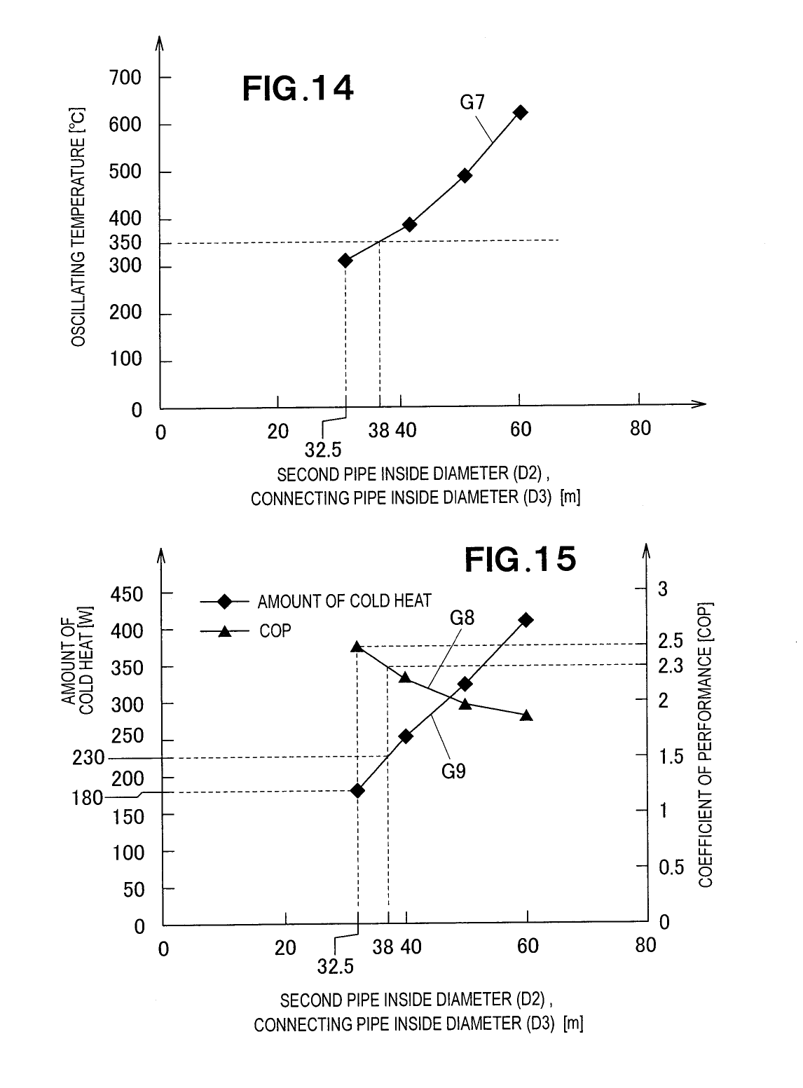

Next, the reason that the cross-sectional area S4 of the second looped pipe 14 and the cross-sectional area S5 of the connecting straight pipe 17 are preferably set to S3×(1.1 to 1.5) relative to the cross-sectional area S3 of the first looped pipe 11 shown in FIG. 9 is described with reference to FIGS. 14 and 15. The second pipe inside diameter D2 and the connecting pipe inside diameter D3 are set to have the relationship D2=D3.

Specifically, the first pipe inside diameter D1 is 31 mm, and the second pipe inside diameter D2 and connecting pipe inside diameter D3 are 32.5 to 38 mm. Another condition of the resonant pipe 18 is that the connecting pipe length L3 of the connecting straight pipe 17 be 4.5 m. The first loop length L1 of the first looped pipe 11 and the second loop length L2 of the second looped pipe 14 are 1.5 m.

FIG. 14 is a graph showing the relationship between the oscillating temperature at which the motor 12 is driven, and the second pipe inside diameter D2 and connecting pipe inside diameter D3, wherein the vertical axis represents the oscillating temperature (° C.) and the horizontal axis represents the second pipe inside diameter D2 (mm) and the connecting pipe inside diameter D3 (mm). A curve G7 represents the relationship between the oscillating temperature and the second pipe inside diameter D2 and connecting pipe inside diameter D3.

FIG. 15 is a graph showing the relationship between the amount of cold heat obtained from the receiver 15 and the second pipe inside diameter D2 and connecting pipe inside diameter D3, and also describing the relationship between the COP of the thermoacoustic engine 200 and the second pipe inside diameter D2 and connecting pipe inside diameter D3. A curve G8 represents the COP of the thermoacoustic engine 200, and a curve G9 represents the amount of cold heat obtained from the receiver 15. The left vertical axis represents the amount of cold heat (W), the right vertical axis represents the COP, and the horizontal axis represents the second pipe inside diameter D2 and connecting pipe inside diameter D3 (mm).

As evidenced by the curve G7 of FIG. 14 and the curves G8 and G9 of FIG. 15, when the second pipe inside diameter D2 and connecting pipe inside diameter D3 are set above 38 mm and the oscillating temperature is increased above 350° C., a sufficient amount of cold heat can be recovered from the receiver 15. However, it is difficult to suitably ensure a COP, and it is also difficult to ensure energy consumption efficiency.

In view of this, the second pipe inside diameter D2 and connecting pipe inside diameter D3 are set to 32.5 to 38 mm and the oscillating temperature is kept at about 350° C. The COP of the thermoacoustic engine 200 can thereby be ensured in a range of 2.3 to 2.5, and a high energy consumption efficiency can be preserved. Furthermore, by setting the second pipe inside diameter D2 and connecting pipe inside diameter D3 to 32.5 to 38 mm and keeping the oscillating temperature at about 350° C., the amount of cold heat obtained from the receiver 15 can be sufficiently increased to 180 to 230 W. Specifically, by setting the cross-sectional area S4 of the second looped pipe 14 and the cross-sectional area S5 of the connecting straight pipe 17 to S3×(1.1 to 1.5) and driving the motor 12 with a heat of about 350° C., a sufficient amount of cold heat can be efficiently obtained (recovered) from the receiver 15.

As shown in FIG. 9, in the thermoacoustic engine 200, the connecting pipe length L3 is set to L1×(3 to 8) relative to the first loop length L1, the second loop length L2 is set to L1×(0.67-less than 1.0) relative to the first loop length L1, and the cross-sectional area S4 of the second looped pipe 14 and the cross-sectional area S5 of the connecting straight pipe 17 are set to S1×(1.1 to 1.5) relative to the cross-sectional area S3 of the first looped pipe 11. An even more sufficient amount of cold heat can thereby be efficiently obtained (recovered) from the receiver 15 when the motor 12 is driven with a heat of about 350° C.

Consequently, as shown in FIG. 8, the waste heat (oscillating temperature) of the cogeneration system 60 (the internal combustion engine) can be used as the heat source 31 due to the first looped pipe 11 of the thermoacoustic engine 200 being accommodated in the casing 62 of the cogeneration system 60. Thereby, the motor 12 can be driven with the waste heat of the cogeneration system 60 (heat of about 350° C.), and a sufficient amount of cold heat can be efficiently recovered from the receiver 15.

The thermoacoustic engine 200 of the present invention is not limited to that of the second embodiment, and can be appropriately modified and improved. For example, in the second embodiment as described above, the connecting pipe length L3 is set to L1×(3 to 8), the second loop length L2 is set to L1×(0.67 to less than 1.0), and the cross-sectional area S4 of the second looped pipe 14 and the cross-sectional area S5 of the connecting straight pipe 17 are set to S1×(1.1 to 1.5), but the invention is not limited to this example.

When the connecting pipe length L3 has been set to L1×(3 to 8), for example, the configuration can be set so as to satisfy at least one of the following conditions: that the second loop length L2 be set to L1×(0.67 to less than 1.0), and that the cross-sectional area S4 of the second looped pipe 14 and the cross-sectional area S5 of the connecting straight pipe 17 be set to S1×(1.1 to 1.5). In this case, a sufficient amount of cold heat can be efficiently obtained (recovered) from the receiver 15 when the motor 12 is driven with a heat of about 350° C.

In the second embodiment described above, cold heat is taken from the receiver 15 to cool a refrigeration unit 61 by transferring heat to the motor 12 from the heat source 31, but the invention is not limited to this example, and heat can also be taken from the receiver 15 to be utilized for indoor heating or the like. Specifically, the second hot-side heat exchanger 47 of the receiver 15 can be heated to obtain (recover) heat, by keeping the second cold-side heat exchanger 48 of the receiver 15 shown in FIG. 8 at ambient temperature, for example. The obtained heat can be utilized to perform indoor heating or the like.

Thus, even when heat for indoor heating is obtained (recovered) from the receiver 15, similar to the embodiments, a sufficient heat amount can be efficiently obtained (recovered) from the receiver 15 by setting the connecting pipe length L3 to L1×(3 to 8) and driving the motor 12 with a heat of about 350° C.

Furthermore, a sufficient heat amount can be efficiently obtained (recovered) from the receiver 15 by setting the second loop length L2 to L1×(0.67 to less than 1.0) and driving the motor 12 with a heat of about 350° C.

Additionally, a sufficient heat amount can be efficiently obtained (recovered) from the receiver 15 by setting the cross-sectional area S4 of the second looped pipe 14 and the cross-sectional area S5 of the connecting straight pipe 17 to S3×(1.1 to 1.5) and driving the motor 12 with a heat of about 350° C.

When the connecting pipe length L3 has been set to L1×(3 to 8), a sufficient heat amount can be efficiently obtained (recovered) from the receiver 15 when the motor 12 is driven with a heat of about 350° C., by satisfying at least one of the following conditions: that the second loop length L2 be set to L1×(0.67 to less than 1.0), and that the cross-sectional area S4 of the second looped pipe 14 and the cross-sectional area S5 of the connecting straight pipe 17 be set to S3×(1.1 to 1.5).

### Third Embodiment

Next, the thermoacoustic engine 300 in Embodiment 3 is described. When the thermoacoustic engine 300 in Embodiment 3 is described, members identical to those of the thermoacoustic engine 10 in Embodiment 1 are described using the same reference numbers.

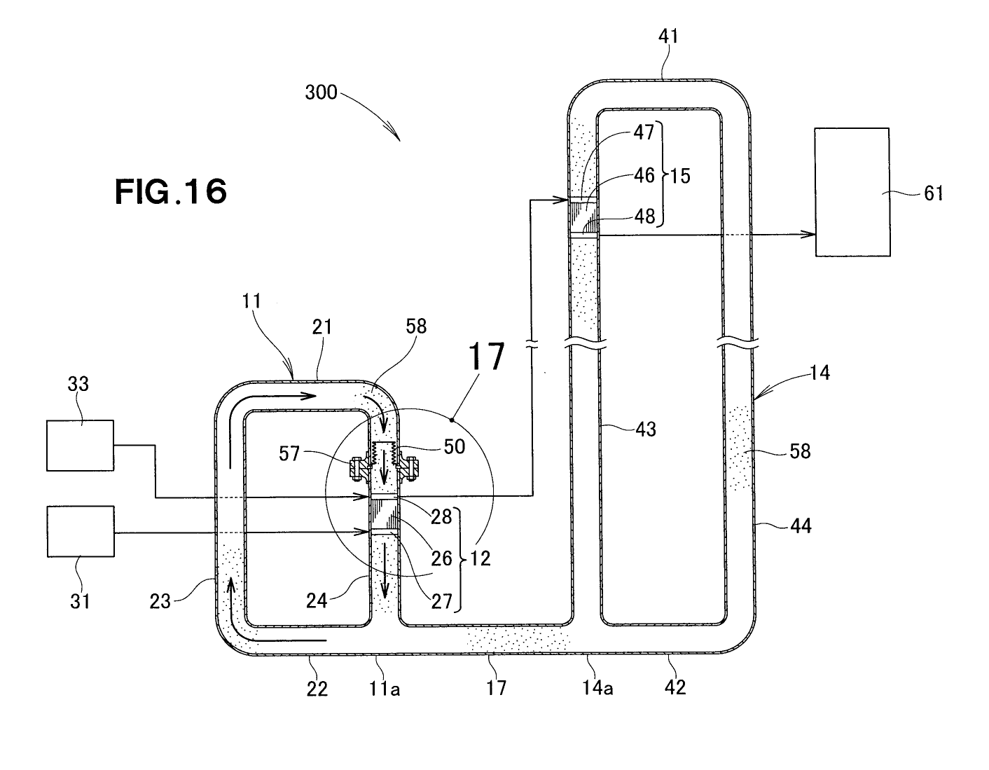

As shown in FIG. 16, a thermoacoustic engine 300 according to a third embodiment includes a first looped pipe (a looped pipe) 11 formed into a looped shape, a motor 12 provided inside the first looped pipe 11, a convection suppression means 50 provided in proximity to the motor 12, a second looped pipe (a looped pipe) 14 formed into a looped shape, a receiver 15 provided inside the second looped pipe 14, and a connecting straight pipe 17 interconnecting the first looped pipe 11 and the second looped pipe 14.

Specifically, the thermoacoustic engine 300 is a so-called double-loop thermoacoustic engine including two looped pipes: the first looped pipe 11 and the second looped pipe 14. An inert gas (i.e. a working fluid or a gas) 58 such as nitrogen, helium, argon, or a mixed gas of helium and argon is sealed as a gas inside the first looped pipe 11, the second looped pipe 14, and the connecting straight pipe 17.

The first looped pipe 11 is a pipe having a circular cross section made from stainless steel, and is formed into a looped shape from top and bottom horizontal pipe sections 21, 22 and left and right vertical pipe sections 23, 24. The motor 12 is provided in the right vertical pipe section 24 of the first looped pipe 11, and the convection suppression means 50 is provided in a connecting part 57 of the right vertical pipe section 24.

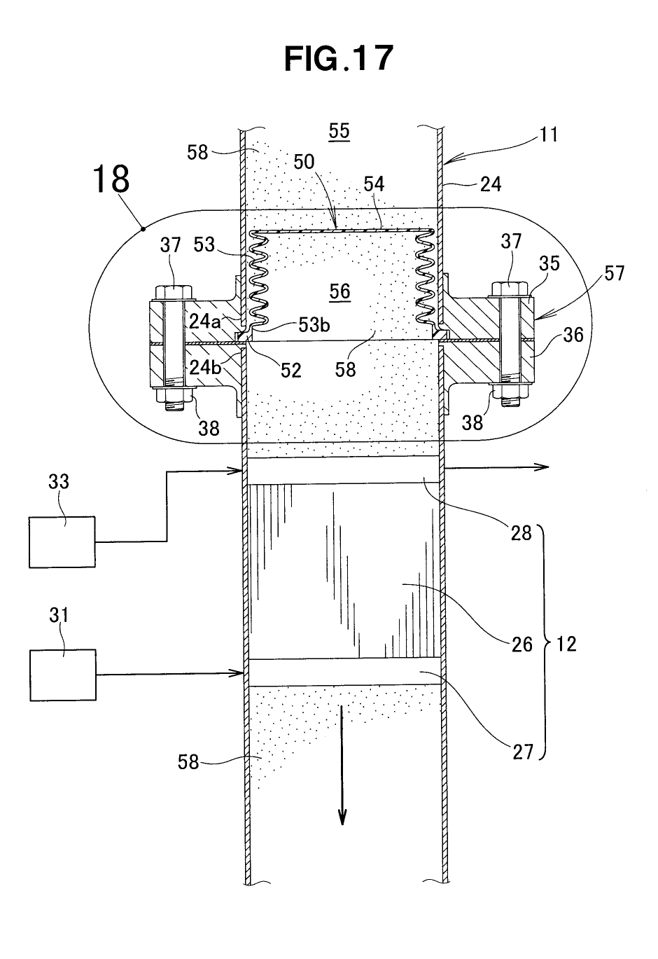

As shown in FIG. 17, the connecting part 57 is provided in the right vertical pipe section 24 of the first looped pipe 11. In the connecting part 57, a top flange 35 is provided at one end 24a of the right vertical pipe section 24, a bottom flange 36 is provided at an opposite end 24b of the right vertical pipe section 24, and the top and bottom flanges 35, 36 are connected by bolts 37 and nuts 38. Connecting the top and bottom flanges 35, 36 preserves a state in which the one end 24a and the opposite end 24b of the right vertical pipe 24 are interconnected.

The motor 12 has a sound wave generating function for converting thermal energy to acoustic energy, i.e. to acoustic vibrations (sound waves). This motor 12 includes a first stack 26 accommodated inside the right vertical pipe section 24, a first hot-side heat exchanger 27 provided at the bottom end of the first stack 26, and a first cold-side heat exchanger 28 provided at the top end of the first stack 26. The first hot-side heat exchanger 27 interconnects with a heat source 31 (FIG. 16) which is capable of supplying waste heat of an internal combustion engine, for example. The first cold-side heat exchanger 28 interconnects with a cooling water supply source 33 (FIG. 16) capable of supplying cooling water.

The first hot-side heat exchanger 27 of the motor 12 is heated by the heat source 31, and the first cold-side heat exchanger 28 of the motor 12 is cooled by the cooling water supply source 33. The first stack 26 thereby oscillates, and the working fluid 58 in the right vertical pipe section 24 undergoes self-exited oscillation. Due to self-excited oscillation of the working fluid 58, acoustic vibrations (sound waves) are generated in the first looped pipe 11, and the generated sound waves are transmitted as shown by the arrows.

In the direction of sound wave transmission, the first cold-side heat exchanger 28 side (the cold side) of the motor 12 is the downstream side, and the first hot-side heat exchanger 27 side (the hot side) of the motor 12 is the upstream side. Consequently, the connecting part 57 of the right vertical pipe section 24 is provided near the cold-side heat exchanger 28 side (the cold side) of the motor 12, i.e. near the downstream side of the motor 12. Due to the convection suppression means 50 being sandwiched between the top and bottom flanges 35, 36 of the connecting part 57, the convection suppression means 50 is provided in proximity to the downstream side of the motor 12.

The sound waves generated by the oscillation of the motor 12 are transferred in the direction of the arrows (downstream). Consequently, the sound waves have greater velocity amplitude on the upstream side of the motor 12. Therefore, when the convection suppression means 50 is provided on the upstream side of the motor 12, there is a risk of the resistance of the convection suppression means 50 increasing, leading to a loss of acoustic energy efficiency. In view of this, the convection suppression means 50 is disposed on the downstream side of the motor 12 where the velocity amplitude of the sound waves is low, whereby the resistance of the convection suppression means 50 is kept low and the loss of acoustic energy efficiency is kept to a minimum.

The heat transferred to the motor 12 from the heat source 31 is transferred from the hot side of the motor 12 (the first hot-side heat exchanger 27 side) in the direction of acoustic energy transmission (the direction of the arrows, i.e. downstream). In view of this, in the motor 12, the convection suppression means 50 is provided to the cold side positioned opposite of the hot side. Consequently, it is possible to prevent the convection suppression means 50 from being affected by heat transferred to the motor 12. The convection suppression means 50 can be prevented from deteriorating due to the effects of heat transferred to the motor 12, and the durability of the convection suppression means 50 can be further ensured.

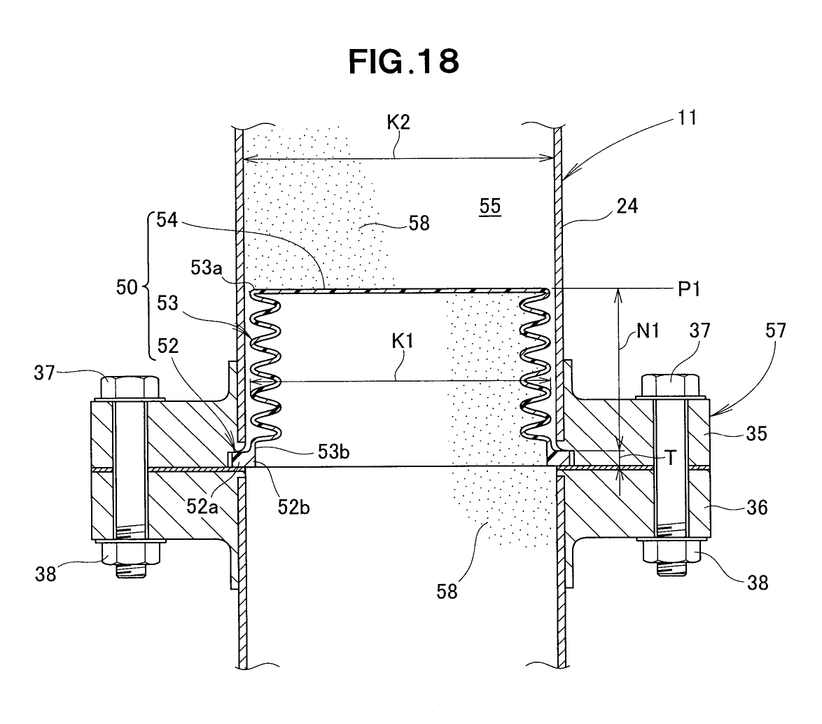

As shown in FIG. 18, the convection suppression means 50 is formed from an elastic member (one example being silicone rubber), and is a film member partitioning the interior of the right vertical pipe section 24. The convection suppression means 50 has a supported part 52 sandwiched between the top and bottom flanges 35, 36 of the right vertical pipe section 24, a cylindrical accordion or bellows-shaped wall part 53 extending from the supported part 52, and a crown or top part 54 closing an distal end portion 53a of the wall part 53.

The supported part 52 is formed into an annular shape, and is supported by the connecting part 57 of the right vertical pipe 24 due to the outer periphery 52a thereof being sandwiched between the top and bottom flanges 35, 36. The inner periphery 52b of the supported part 52 is disposed inside the right vertical pipe section 24, and the wall part 53 is provided in the inner periphery 52b.

The wall part 53 has a base portion 53b integral with an inner periphery 52b of the supported part 52, and the wall part is formed thin in a cylindrical bellows shape along the inner wall of the right vertical pipe section 24. The wall part 53 is formed into a cylinder having an outside diameter K1 smaller than the inside diameter K2 of the right vertical pipe section 24, and is capable of extending and contracting due to being folded into a bellows shape. Due to the outside diameter K1 of the wall part 53 being formed smaller than the inside diameter K2 of the right vertical pipe section 24, when the wall part 53 is accommodated, the wall part 53 can be prevented from contacting the right vertical pipe 24. The top part 54 is integral with a distal end portion 53a of the wall part 53.

The top part 54 is a circular plate-shaped region formed integrally with the distal end portion 53a of the wall part 53 with the same thickness (thinness) as the wall part 53. Providing the top part 54 with the distal end portion 53a of the wall part 53 causes the distal end portion 53a of the wall part 53 to be closed up by the top part 54. Forming the top part 54 from silicone rubber with the same thickness as the wall part 53 makes it possible to reduce the weight of the top part 54, similar to the wall part 53.

Thus, the weight of the wall part 53 and the top part 54 are reduced, removing any risk that the extending and contracting of the wall part 53 will be inhibited by the weight of the wall part 53 or the top part 54, and the acoustic energy for extending and contracting the wall part 53 can be kept low. Sound waves can thereby be efficiently transmitted between one side (the upstream side) 55 and the other side (the downstream side) 56 of the convection suppression means 50, and acoustic energy can be suitably recovered.

The convection suppression means 50 is set such that the thickness of the supported part 52 is T, and the natural length (or free length) of the wall part 53 is N1. The natural length N1 of the wall part 53 is the length of the accordion-shaped wall part 53 in a natural un-extended and un-contracted state. When the wall part 53 is in the natural length N1, the end part 53a of the wall part 53 is positioned in a natural position P1.

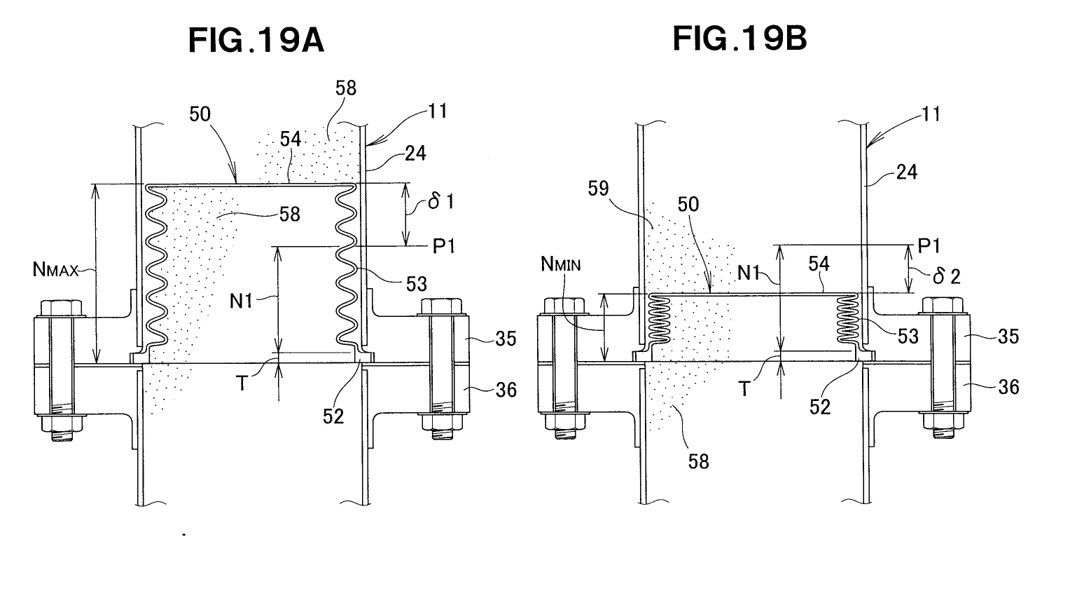

As shown in FIGS. 19A and 19B, the convection suppression means 50 is vibrated by pressure amplitude Pr of the working fluid 58 sealed inside the first looped pipe 11, the second looped pipe 14, and the connecting straight pipe 17. Due to the vibrating of the convection suppression means 50, the wall part 53 extends and contracts from the natural position P1. Specifically, in the convection suppression means 50, the film thickness and shapes of the wall part 53 and top part 54 are set so that an amount of elongation of the wall part 53 is δ1 and an amount of contraction of the wall part 53 is δ2.

Consequently, the maximum length N_{MAX} of the convection suppression means 50 is a value obtained by adding the thickness T of the supported part 52, the natural length N1, and the amount of elongation δ1. Specifically, the maximum length N_{MAX}=T+N1+δ1. The minimum length N_{MIN} of the convection suppression means 50 is a value obtained by subtracting the amount of contraction δ2 from the sum total of the thickness T of the supported part 52 and the natural length N1. Specifically, the minimum length N_{MIN}=T+L1−δ2.

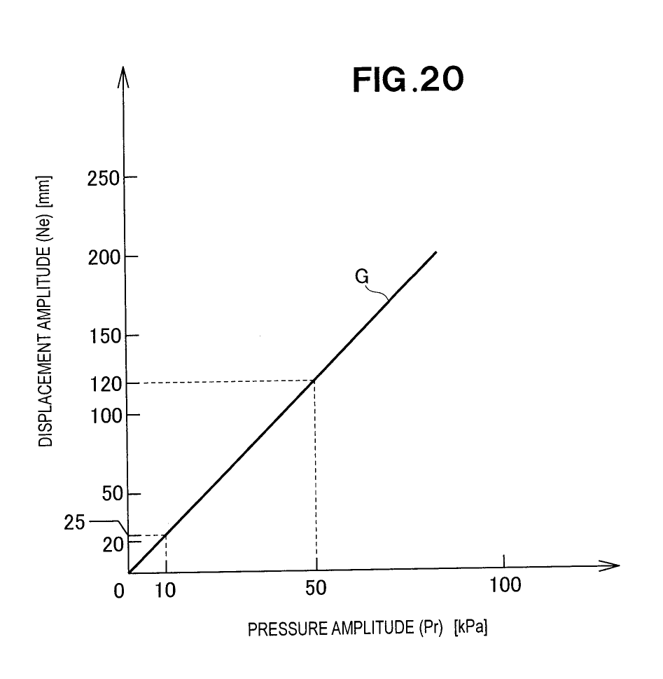

The amount of elongation and contraction (δ1+δ2) of the wall part 53 is described with reference to FIGS. 19A and 19B and the graph of FIG. 20. FIG. 20 is a graph showing the relationship between the pressure amplitude Pr and the displacement amplitude Ne of sound waves transmitted through the working fluid 58, wherein the vertical axis represents the displacement amplitude Ne (mm) and the horizontal axis represents the pressure amplitude Pr (kPa). The relationship between the displacement amplitude Ne and the pressure amplitude Pr was determined as follows. The displacement amplitude Ne is the length of a section through which the sound waves move in one cycle.

The amplitude is obtained as a function of velocity amplitude and frequency, by integrating the velocity fluctuation of the sound waves as presumably a sin function. A value twice the obtained amplitude is the peak-to-peak displacement (referred to as the “displacement amplitude Ne” below.) The displacement amplitude Ne and the pressure amplitude Pr have the following relationship.

Ne=Pr/(π×f×Zo) (1)

Where
Ne: displacement amplitude
Pr: pressure amplitude
f: frequency
Zo: characteristic acoustic impedance

The thermoacoustic engine 300 is set such that the internal pressure of the first looped pipe 11, the second looped pipe 14, and the connecting straight pipe 17 (FIG. 16) is normally 1 MPa or less. As a test condition for estimating the displacement amplitude Ne of the sound waves, 1 MPa of helium (i.e. the working fluid 58) was sealed in the first looped pipe 11, the second looped pipe 14, and the connecting straight pipe 17. The Zo of the 1 MPa of helium is expressed by the following formula.

Zo=ρ×c

Where
ρ: density (1.6 kg/m³)
c: speed of sound (1000 m/sec)

Consequently, the displacement amplitude Ne of the sound waves can be estimated by substituting the pressure amplitude Pr and frequency f obtained from the test data into formula 1. The relationship between the estimated displacement amplitude Ne and pressure amplitude Pr is shown by a line G of FIG. 20.

When the internal pressure of the thermoacoustic engine 300 has been set to 1 MPa or less, it is presumed that the pressure amplitude Pr of the first looped pipe 11, the second looped pipe 14, and the connecting straight pipe 17 will not increase above 50 kPa. The pressure amplitude Pr of the first looped pipe 11, the second looped pipe 14, and the connecting straight pipe 17 could also possibly be less than 10 kPa.

However, when a convection suppression means 40 is used which has an amplitude amount corresponding to a pressure amplitude Pr less than 10 kPa, there is a high possibility of severe attenuation of the acoustic energy (sound waves) in the convection suppression means 40, and it is difficult to suitably recover the acoustic energy. In view of this, the pressure amplitude Pr generated in the first looped pipe 11, the second looped pipe 14, and the connecting straight pipe 17 (FIG. 16) of the thermoacoustic engine 300 was set to 10 to 50 kPa.

As is apparent from the line G shown in FIG. 20, when the pressure amplitude Pr is 50 kPa, the displacement amplitude Ne of the working fluid 58 sealed inside the first looped pipe 11, the second looped pipe 14, and the connecting straight pipe 17 is 120 mm. When the displacement amplitude Ne of the convection suppression means 50 exceeds 120 mm, it is believed that the convection suppression means 50 could deform due to the weight thereof. When the convection suppression means 50 deforms due to the weight thereof, it is difficult to cause the convection suppression means 50 to vibrate suitably.

When the pressure amplitude Pr is 10 kPa, the displacement amplitude Ne of the working fluid 58 sealed inside the first looped pipe 11, the second looped pipe 14, and the connecting straight pipe 17 is 25 mm. Inasmuch, the displacement amplitude Ne of the working fluid 58 is set within a range of 25 to 120 mm. The displacement amplitude Ne of the working fluid 58 is equivalent to the amount of elongation and contraction (δ1+δ2) of the wall part 53. The amount of elongation and contraction (δ1+δ2) of the wall part 53 is thereby set within a range of 25 to 120 mm.

As shown in FIG. 16, the second looped pipe 14 is a pipe having a circular cross section made of stainless steel, similar to the first looped pipe 11, and is formed into a looped shape from top and bottom horizontal pipe sections 41, 42 and left and right vertical pipe sections 43, 44. A receiver 15 is provided in the left vertical pipe section 43 of the second looped pipe 14.

The receiver 15 has a thermal storage function for converting acoustic energy (sound waves) transmitted to the second looped pipe 14 to thermal energy. This receiver 15 includes a second stack 46 accommodated inside the left vertical pipe section 43, a second hot-side heat exchanger 47 provided at the top end of the second stack 46, and a second cold-side heat exchanger 48 provided at the bottom end of the second stack 46. The second hot-side heat exchanger 47 interconnects with the cooling water supply source 33 via the first cold-side heat exchanger 28. The second cold-side heat exchanger 48 interconnects with the refrigeration unit 61.

The first looped pipe 11 and the second looped pipe 14 are interconnected by the connecting straight pipe 17. Specifically, the connecting straight pipe 17 is a pipe having a circular cross section made from stainless steel, similar to the first looped pipe 11 and the second looped pipe 14, and is made to extend in a straight line so that the right bottom part 11a of the first looped pipe 11 and the left bottom part 14a of the second looped pipe 14 are communicated. A working fluid 58 is sealed inside the first looped pipe 11, the second looped pipe 14, and the connecting straight pipe 17.

In the thermoacoustic engine 300, the first hot-side heat exchanger 27 of the motor 12 is heated by the heat source 31, and the first cold-side heat exchanger 28 of the motor 12 is cooled by the cooling water supply source 33. The first stack 26 thereby oscillates, and the working fluid 58 in the right vertical pipe section 24 undergoes self-exited oscillation. Due to self-exited oscillation of the working fluid 58, acoustic vibrations (sound waves) are generated in the first looped pipe 11, and the generated sound waves are transmitted to the receiver 15 via the connecting straight pipe 17 and the second looped pipe 14.

The second hot-side heat exchanger 47 of the receiver 15 is cooled by cooling water led from the first cold-side heat exchanger 28. Consequently, sound waves are transmitted to the receiver 15, whereby the second stack 46 vibrates, and the second cold-side heat exchanger 48 is cooled. The cooling water cooled in the second cold-side heat exchanger 48 is led to the refrigeration unit 61, whereby the refrigeration unit 61 is kept in a cooled state.

As shown in FIG. 17, on the downstream side of the motor 12 and in proximity to the motor 12, the interior of the right vertical pipe section 24 is partitioned by the film-shaped convection suppression means 50. Due to the interior of the right vertical pipe 24 being partitioned by the film-shaped convection suppression means 50, convection created in the working fluid 58 can be suppressed by the convection suppression means 50. Suppressing convection of the working fluid 58 makes it possible to keep the heat of the motor 12 from moving in correspondence with the flow of the working fluid 58. Keeping the heat from moving makes it possible to prevent reduction in the efficiency of heat exchange by the motor 12. Acoustic energy (sound waves) can thereby be satisfactorily transmitted to the receiver 15 (FIG. 16), and thermal energy can be suitably recovered.

Furthermore, the wall part 53 of the convection suppression means 50 is formed into a cylindrical bellows shape. Consequently, the convection suppression means 50 can be made to vibrate smoothly without applying any more load (stress) than necessary by extending and contracting the wall part 53 formed into a bellows shape. Consequently, excessive loads (stress) can be prevented from acting on the base portion 53b of the wall part 53 connected to the supported part 52. Damage to the base portion 53b of the wall part 53 can thereby be suppressed and the durability of the convection suppression means 50 can be ensured.

Additionally, due to the wall part 53 of the convection suppression means 50 being formed into a cylindrical bellows shape, the energy needed to vibrate (deform) the convection suppression means 50 can be kept low. Thereby, when acoustic energy is transmitted from one side (the upstream side) 55 of the convection suppression means 50 to the other side (the downstream side) 56, the attenuation of the acoustic energy can be kept low and thermal energy can therefore be more suitably recovered.

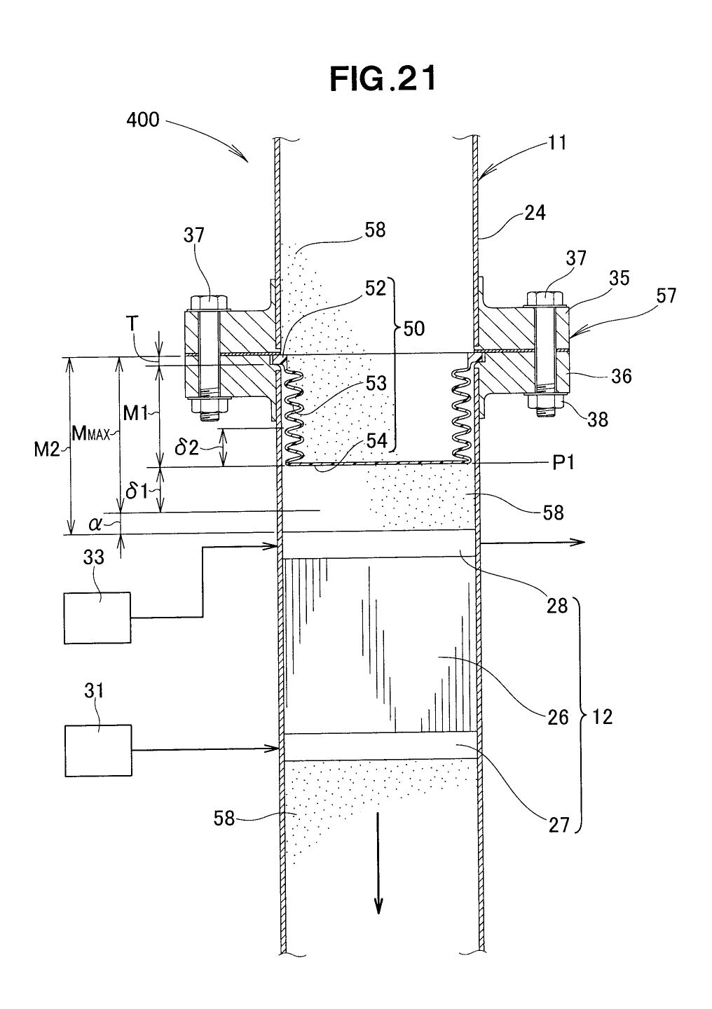

Next, fourth to sixth embodiments of the present invention will be described with reference to FIGS. 21 to 25. In the fourth to sixth embodiments, these members identical or similar to those of the thermoacoustic engine 300 of third embodiment are denoted by the same symbols and are not described.

### Fourth Embodiment

A thermoacoustic engine 400 according to the fourth embodiment is described first. As shown in FIG. 21, in the thermoacoustic engine 400, the convection suppression means 50 is provided in an orientation opposite of the third embodiment whereby the top part 54 of the convection suppression means 50 is disposed facing the motor 12, and the rest of the configuration is therefore identical to that of the thermoacoustic engine 300 of the third embodiment.

The convection suppression means 50 of the fourth embodiment is provided in proximity to the motor 12, the top part 54 is disposed facing the first cold-side heat exchanger 28 of the motor 12, and the supported part 52 is disposed at a position separated from the first cold-side heat exchanger 28 by a distance M2. Specifically, the convection suppression means 50 is disposed at a position separated from the first cold-side heat exchanger 28 by a distance M2. The distance M2 is set to be greater by an amount a than the maximum length M_{MAX} of the convection suppression means 50. The maximum length M_{MAX} of the convection suppression means 50 is a value obtained by adding the thickness T of the supported part 52, the natural length M1, and the amount of elongation δ1, i.e. (T+M1+δ1).

The sum total of the thickness T of the supported part 52 and the natural length M1 (T+M1) is the natural length of the convection suppression means 50. Consequently, the distance M2 is greater by an amount a than the maximum length M_{MAX}, which is the amount of elongation δ1 of the wall part 53 added to the natural length of the convection suppression means 50 (T+M1). Thereby, when the convection suppression means 50 vibrates and extends to the maximum length M_{MAX}, the convection suppression means 50 can be prevented from interfering with the motor 12. The convection suppression means 50 can thereby be kept from interfering with and damaging the motor 12, and the durability of the convection suppression means 50 can be ensured.

### Fifth Embodiment

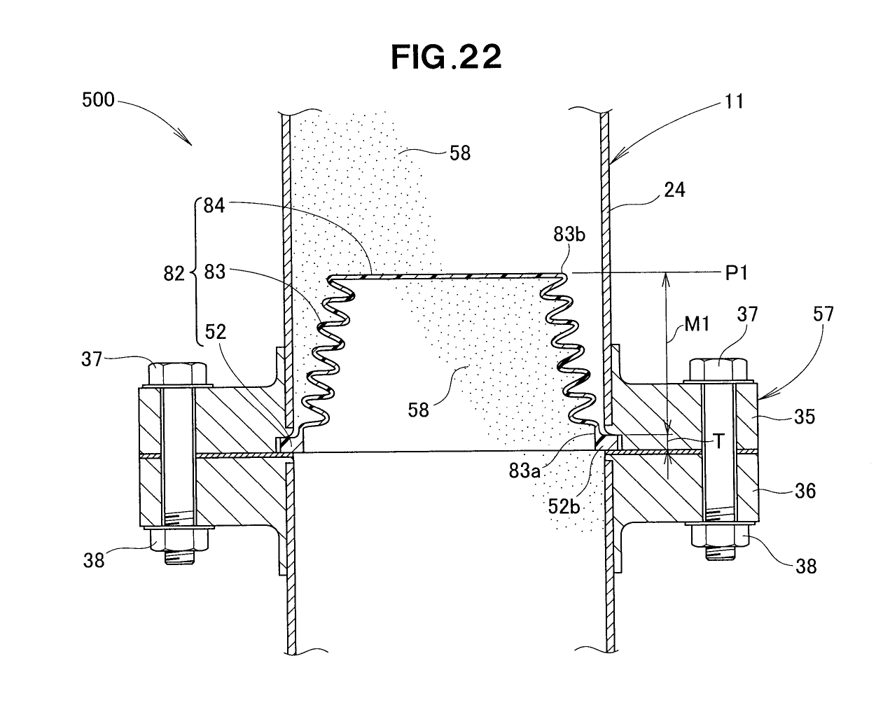

Next, a thermoacoustic engine 500 according to the fifth embodiment is described. As shown in FIG. 22, the thermoacoustic engine 500 has a convection suppression means 82 instead of the convection suppression means 50 of the third embodiment, and the rest of the configuration is identical to that of the thermoacoustic engine 300 of the third embodiment.

The convection suppression means 82 of the fifth embodiment is set so that the diameter of a wall part 83 gradually decreases from a base portion 83a to a distal end portion 83b, and the rest of the configuration is identical to that of the convection suppression means 50 of the third embodiment. The wall part 83 is formed to be capable of extending and contracting, the base portion 83a is formed integrally with an inner periphery 52b of the supported part 52, and the distal end portion 83b is closed by a crown or top part 84.

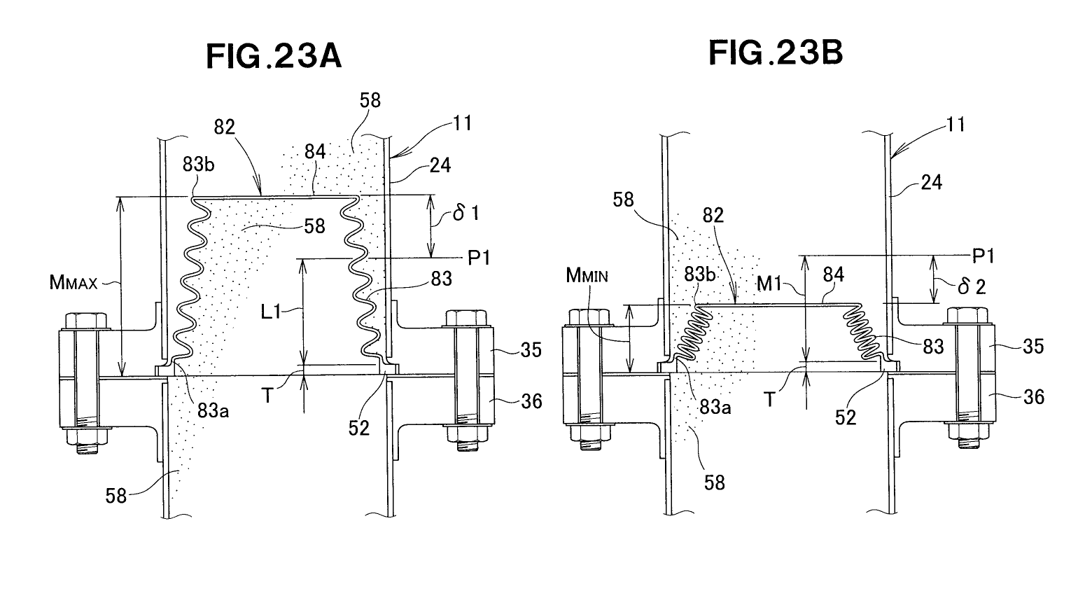

As shown in FIGS. 23A and 23B, in the convection suppression means 82, the film thickness dimensions and shapes of the wall part 83 and top part 84 are set so that the amount of elongation of the wall part 83 is δ1 and the amount of contraction of the wall part 83 is δ2, similar to the convection suppression means 50 of the third embodiment.

The reason that the diameter of the wall part 83 is set so as to gradually decrease from the base portion 83a to the distal end portion 83b is as follows. Specifically, it is believed that the outside diameter of the wall part 83 is increased by the contracting of the bellows-shaped wall part 83, and there is friction between the wall part 83 and the right vertical pipe section (the pipe wall) 24.

In view of this, the diameter of the wall part 83 is set so as to gradually decrease from the base portion 83a to the distal end portion 83b. Consequently, the gaps between adjacent sides of the bellows-shaped wall part 83 can be ensured to gradually increase from the base portion 83a to the distal end portion 83b. Thereby, when the bellows-shaped wall part 83 has been contracted, the bellows-shaped wall part 83 can be prevented from coming in contact with the right vertical pipe section (the pipe wall) 24 and friction between the wall part 83 and the right vertical pipe section (the pipe wall) 24 can be prevented.

### Sixth Embodiment

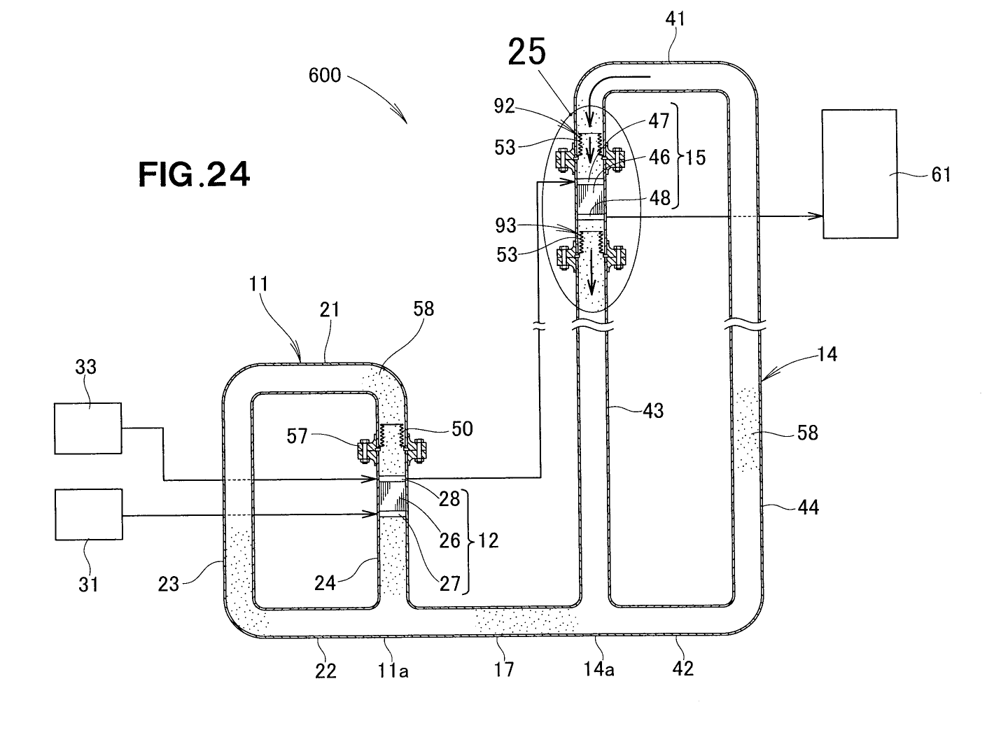

A thermoacoustic engine 600 according to the sixth embodiment is described. As shown in FIG. 24, the thermoacoustic engine 600 is provided with top and bottom convection suppression means (convection suppression means) 92, 93 in proximity to the receiver 15 in addition to the convection suppression means 50 of the third embodiment, and the rest of the configuration is identical to that of the thermoacoustic engine 300 of the third embodiment.

Specifically, the top convection suppression means 92 is provided in the vicinity of the second hot-side heat exchanger 47 side (i.e. the hot side) of the receiver 15. Furthermore, the bottom convection suppression means 93 is provided in the vicinity of the second cold-side heat exchanger 48 side (i.e. the cold side) of the receiver 15. Sound waves in the second looped pipe 14 are transmitted as shown by the arrows. Consequently, in the direction that sound waves are transmitted, the second hot-side heat exchanger 47 side (the hot side) of the receiver 15 is the upstream side, and the second cold-side heat exchanger 48 side (the cold side) of the receiver 15 is the downstream side. The top and bottom convection suppression means 92, 93 are configured identical to the convection suppression means 50 of the third embodiment, the same symbols are assigned to the structural components, and descriptions are omitted.

The receiver 15 has a function for cooling the refrigeration unit 61 by converting acoustic energy (sound waves) transmitted to the second looped pipe 14 into thermal energy. Consequently, no large amount of heat is generated in the upstream side or downstream side of the receiver 15. Thereby, even if the top and bottom convection suppression means 92, 93 are provided in the vicinities of both sides (the upstream side and downstream side) of the receiver 15, there is no risk of the top and bottom convection suppression means 92, 93 deteriorating due to the heat of the receiver 15.

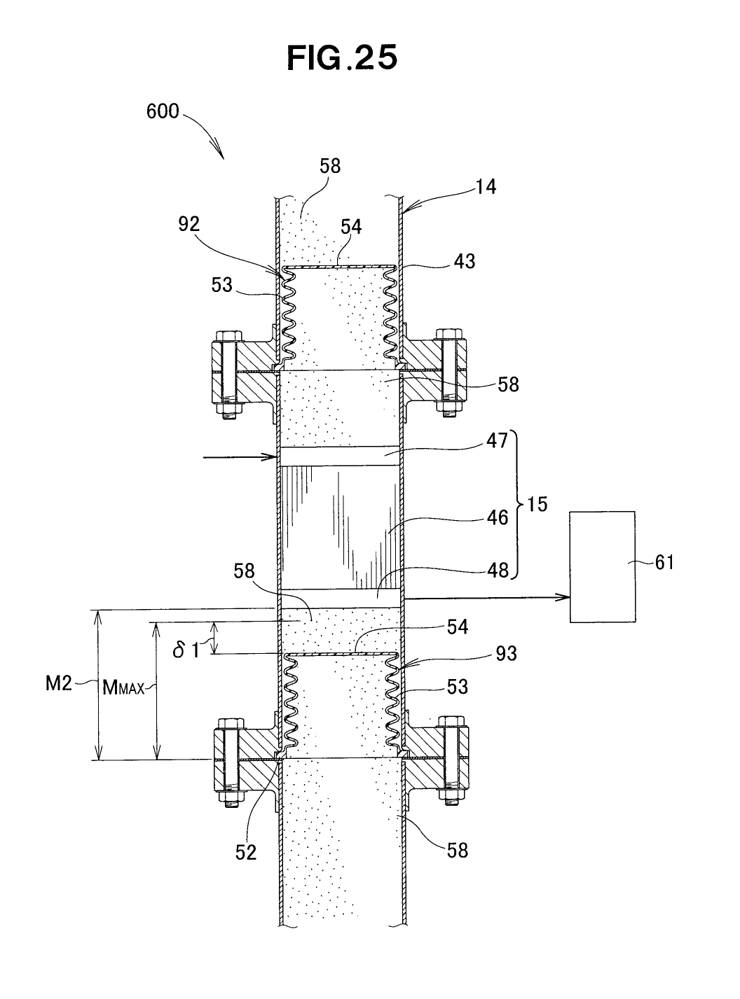

As shown in FIG. 25, in the bottom convection suppression means 93, similar to the convection suppression means 50 of the fourth embodiment, the top part 54 is disposed on the second cold-side heat exchanger 48 side of the receiver 15. Consequently, in the bottom convection suppression means 93, the supported part 52 is disposed at a position separated from the second cold-side heat exchanger 48 by a distance M2. The distance M2 is set to be greater than the maximum length M_{MAX} of the bottom convection suppression means 93. The maximum length M_{MAX} of the bottom convection suppression means 93 is a value obtained by adding the amount of elongation δ1 of the wall part 53 to the natural length of the bottom convection suppression means 93.

Due to the bottom convection suppression means 93 being disposed at a position separated from the second cold-side heat exchanger 48 by a distance M2, when the bottom convection suppression means 93 vibrates and extends to the maximum length M_{MAX}, the bottom convection suppression means 93 can be prevented from interfering with the receiver 15. The bottom convection suppression means 93 can thereby be kept from interfering with and damaging the receiver 15, and the durability of the bottom convection suppression means 93 can be ensured.

Furthermore, in the thermoacoustic engine 600, on the upstream side of the receiver 15 and in the vicinity of the receiver 15, the interior of the left vertical pipe section 43 is partitioned by the film-shaped top convection suppression means 92. On the downstream side of the receiver 15 and in the vicinity of the receiver 15, the interior of the left vertical pipe section 43 is partitioned by the film-shaped bottom convection suppression means 93. Due to the interior of the left vertical pipe section 43 being partitioned by the film-shaped top and bottom convection suppression means 92, 93, convection in the working fluid 58 can be suppressed by the top and bottom convection suppression means 92, 93 in the upstream vicinity and downstream vicinity of the receiver 15.

Suppressing convection of the working fluid 58 makes it possible to keep the heat of the receiver 15 from moving in correspondence with the flow of the working fluid 58. Keeping the heat from moving makes it possible to prevent reduction in the efficiency of heat exchange by the receiver 15. Acoustic energy (sound waves) can thereby be satisfactorily converted to thermal energy by the receiver 15, and thermal energy can be suitably recovered.

The thermoacoustic engine according to the present invention is not limited to the illustrated embodiments and can be suitably modified, improved, or otherwise altered. For example, in the third to sixth embodiments, cold heat is taken from the receiver 15 to cool the refrigeration unit 61 by transferring heat from the heat source 31 to the motor 12, but the invention is not limited to this example, and heat can also be taken from the receiver 15 and utilized for indoor heating or the like. Specifically, the second hot-side heat exchanger 47 of the receiver 15 is heated and heat is obtained (recovered) by keeping the second cold-side heat exchanger 48 of the receiver 15 shown in FIG. 16 at ambient temperature, for example. The obtained heat can be utilized to perform indoor heating or the like.

In the sixth embodiment, the top and bottom convection suppression means 92, 93 are provided in the vicinities of both sides (the upstream side and the downstream side) of the receiver 15, but the invention is not limited to this example; it is also possible to provide convection suppression means to at least one location in the vicinities of both sides (the upstream side and the downstream side) of the receiver 15.

Furthermore, in the sixth embodiment, the top part 54 of the top convection suppression means 92 is disposed at a position separated from the second hot-side heat exchanger 47 side of the receiver 15, but the invention is not limited to this example; it is also possible for the top convection suppression means 92 to face the other direction and the top part 54 to be provided to the second hot-side heat exchanger 47 side.

Furthermore, the shapes and configurations of the thermoacoustic engines 10, 200, 300, 400, 500, 600, the first looped pipe 11, the motor 12, the second looped pipe 14, the upstream receiver 15, the downstream receiver 16, the connecting straight pipe 17, the resonant pipe, the upstream tiny flow channels 51, the downstream tiny flow channels 71, the convection suppression means, and other components shown in the illustrated first to sixth embodiments are not limited to those exemplified; suitable modifications can be made.

Obviously, various minor changes and modification of the present invention are possible in light of the above teaching. It is therefore to be understood that within the scope of the appended claims the invention may be practiced otherwise than as specifically described.

What is claimed is:

1. A thermoacoustic engine, comprising:
a first looped pipe provided with a motor configured to convert thermal energy into acoustic energy;
a second looped pipe provided with a receiver configured to convert the acoustic energy converted by the motor into thermal energy; and
a connecting straight pipe interconnecting the first looped pipe and the second looped pipe,
wherein a loop length between one end and an opposite end of the second looped pipe is set to L;
wherein the one end and the opposite end of the second looped pipe are connected with the connecting straight pipe such that acoustic energy is transmitted from the one end to the opposite end of the second looped pipe, and
wherein the receiver is disposed within the second looped pipe in a region separated from the one end toward the opposite end by L×(0.6-1).

2. The thermoacoustic engine of claim 1, wherein a plurality of receivers are provided in the second looped pipe, each of the receivers is provided with flow channels along the second looped pipe, and the flow channels of one of the receivers which is located near the one end of the second looped pipe have a cross-sectional area greater than a cross-sectional area of the flow channels of another receiver which is located near the opposite end of the second looped pipe.

3. A thermoacoustic engine, comprising:
a first looped pipe provided with a motor configured to convert thermal energy into acoustic energy;
a second looped pipe provided with a receiver configured to convert the acoustic energy converted by the motor into thermal energy; and
a connecting straight pipe interconnecting the first looped pipe and the second looped pipe,
wherein a connecting pipe length of the connecting straight pipe is set to be 3 to 8 times a first loop length of the first looped pipe, and
wherein a second loop length of the second looped pipe is set to be shorter than the first loop length.

4. The thermoacoustic engine of claim 3, wherein a connecting pipe inside diameter of the connecting straight pipe and a second pipe inside diameter of the second looped pipe are set larger than a first pipe inside diameter of the first looped pipe.

5. A thermoacoustic engine in which a motor and a receiver are provided inside a looped pipe, a working fluid is sealed inside the looped pipe, thermal energy is converted into acoustic energy by the motor, and acoustic energy is converted into thermal energy by the receiver; wherein
a convection suppression means for suppressing convections in the working fluid is provided at at least one of a cold side of the motor, a cold side of the receiver, and a hot side of the receiver; and
the convection suppression means is a film member formed from an elastic material and partitioning the interior of the looped pipe, wherein the convection suppression means has a supported part supported on the looped pipe, a wall part having a base portion integral with the supported part and capable of extending and contracting due to being formed into a cylindrical bellows shape along the looped pipe, and a top part closing a distal end portion of the wall part.

6. The thermoacoustic engine of claim 5, wherein the convection suppression means is located at a position in proximity to the motor and the receiver and separated by a distance which is at least an amount of elongation of the wall part added to a natural length of the convection suppression means.

7. The thermoacoustic engine of claim 5, wherein the wall part has a diameter set to gradually decrease from the base portion toward the distal end portion.
